(19) United States
(12) Patent Application Publication
(10) Pub. No.: US 2026/0288769 A1
(43) Pub. Date: Sep. 24, 2026

(54) SEMANTIC CONTENT INGESTION IN AN ARTIFICIAL INTELLIGENCE SYSTEM

(71) Applicant: Microsoft Technology Licensing, LLC, Redmond, WA (US)

(72) Inventors: Charlie CORREDOR, Seattle, WA (US); Neetha Sumana TULURI, Sammamish, WA (US); Esteban Ronaldo SMITS, Sachse, TX (US); Sumukh CHITRASHEKAR, Santa Clara, CA (US); Christoffer Benjamin ROSEN, Seattle, WA (US); Sunghwa JIN, Bellevue, WA (US); John Ronald BERKELEY, Kenmore, WA (US); Jaspreet Singh DHINGRA, New Delhi (IN); Ana Monica IRIMIA, Zurich (CH); Mayank VARSNEY, Bothell, WA (US); Christina Juliet STANLEY, Snoqualmie, WA (US); Shweta GARG, Ghaziabad (IN); Jayant Kishorbhai MANGLANI, Redmond, WA (US)

(21) Appl. No.: 19/083,160

(22) Filed: Mar. 18, 2025

(51) Int. Cl. G06F 16/31; G06F 9/48; G06F 9/50; G06F 40/205; G06F 40/30

(52) U.S. Cl. CPC G06F 16/31; G06F 9/4881; G06F 9/5038; G06F 40/205; G06F 40/30; G06F 2209/5021

(57) ABSTRACT

Methods, systems, and computer storage media for ingesting content in an artificial intelligence system are described. A request for priority ingestion of content comprising a set of documents is received. The request for priority ingestion is indicated to a document upload queue. The documents are uploaded to the document upload queue while concurrently parsing the documents to identify semantic content within the document. The semantic content is then analyzed to generate and store indices of the document that indicate locations within the documents of the semantic content. The documents and the indices are then stored within a shared data access system.

### BACKGROUND

Users rely on Artificial Intelligence (AI) systems to efficiently retrieve and synthesize relevant information to generate insightful responses to their queries for informed decision-making. An AI system is a platform designed to perform tasks that typically require human intelligence, such as understanding language, recognizing patterns, and making decisions, often through learning from data. In particular, AI systems can analyze large datasets to identify trends and provide insights that assist in strategic planning. For example, an AI system can understand written or spoken commands and generate responses using language models.

### SUMMARY

Various aspects of the technology described herein are generally directed to systems, methods, and computer storage media for, among other things, providing prioritized ingestion of contextual data to generate responses in an artificial intelligence (AI) system including, but not limited to, large-scale and/or distributed AI systems. An AI system supports generating answers to queries by retrieving relevant information from its knowledge base and using natural language processing to synthesize and articulate coherent, contextually appropriate responses. Prioritized ingestion of contextual data is a systematic approach that adds contextually relevant information to an AI system, using a parallel and/or distributed semantic indexing pipeline that parses, vector, enriches, and stores contextual data in a scalable way. This enables priority ingestion of contextual data, using these scalable resources, so that contextual data can be used to generate accurate and relevant responses to user queries that consider the context of the queries in near real-time. As used herein, context, context information, and contextual data refer to data that provides context for a language model to enhance the relevance and interpretability of queries. Such context, which is typically in the form of supporting documents, but can include emails, chats, multimedia content (for example, audio, video, graphics, images, etc.), system originated, and/or external content, enables an AI system to incorporate the contextual documents and provide contextually relevant responses. The AI system integrates the dense context into queries to reframe queries in a manner that makes it easier to generate more accurate and contextually relevant responses. By leveraging the context, the AI system ensures that the responses are not only informed by general information but also tailored to the user's specific needs and the organizational environment as represented by the context associated with the query.

Prioritized ingestion of such context enables the AI system to provide contextually relevant responses to user queries faster and with more accuracy. As described herein, a user can submit a query to an AI system and request that the contextual documents be ingested with priority (also referred to herein as “with high priority”) or not (for example, by using standard ingestion). When a request includes an indication that the contextual documents should be ingested with priority, the AI system uses the parallel and/or distributed semantic indexing pipeline to parse, vector, index, enrich, and store contextual data. This enables priority ingestion of contextual data, using these scalable resources, so that contextual data can be used to generate accurate and relevant responses to user queries that consider the context of the queries in near real-time or more rapidly than with using a standard ingestion approach.

Conventionally, AI systems are not configured with a comprehensive computing logic and infrastructure to efficiently and effectively respond to queries with specific context (for example, organizational or domain-specific information). Traditional fine-tuning and retrieval-augmented generation (RAG) methods for large language models (LLMs) face significant challenges in interpreting user queries in specific contexts. The complexity and redundancy of contextual information, which is often represented in multiple documents, can complicate effective integration of the contextual data. Additionally, post-training processes require carefully designed methodologies to integrate new knowledge while preserving existing capabilities, as flawed approaches can lead to catastrophic forgetting or degraded performance. The precision of query formulation is also crucial, as poorly formed queries without proper context can yield negative results including false answers and hallucinations. These issues highlight the need for context-aware retrieval strategies that align model outputs with the specific requirements of the query. While RAG can effectively extract information when given well-structured queries, its performance is limited by the quality of embedding models, which often lack the flexibility of LLMs. Effective post-training can enhance reasoning and memorization within a specific corpus, but achieving this balance requires meticulous planning. Overall, improving LLMs for enterprise use requires innovative technology to enhance context interpretation, refine query formulation, and optimize post-training methodologies.

Incorporating context into an AI system typically involves uploading documents that contain the context data, parsing the documents, generating metadata about each of the documents, and incorporating that metadata into the query to provide the context. However, these various processes can be complex and can require significant time and computational resources in systems including, but not limited to, distributed and/or large systems. For example, if a user were to query an AI system to “generate a description of the state of current research in this field based on these fifty recent articles,” the user would want a response quickly. However, uploading the documents, parsing the documents, generating metadata about each of the documents, and incorporating that metadata requires significant time and computational resources and can introduce considerable delays in generating a response.

A technical solution can include providing a priority ingestion of contextual data for use by AI systems and other computing systems that supports adding the contextual data into the AI system and making that contextual data available for queries. The prioritized content ingestion component of a content ingestion system (for example, data, operations, and interfaces) supports prioritized document incorporation to quickly provide context for responses to user queries using the context data in the documents. As described herein, the prioritized content ingestion component of a content ingestion system adds contextually relevant information to an AI system so that context can be used to inform responses to user queries, using a parallel and/or distributed semantic indexing pipeline that parses, vectors, enriches, and stores contextual data in a scalable way. Context data can include, for example, a comprehensive document corpus, contextual metadata, and/or user profiles to tailor outputs to specific needs. Operations of the context ingestion system and the associated resources can include prioritized context ingestion, which uses a scalable pipeline to extract key findings and summarize essential information from documents using natural language processing techniques as well as contextual response generation that uses the ingested context to enrich user queries with relevant contextual information to produce accurate and context-aware answers. The contextual information, which is also referred to herein as an enterprise item, is tokenized into individual word components based on the search schema, enabling it to be searchable, refinable, and queryable. Additionally, semantic embeddings are generated based on the content, allowing the item to be discovered through natural language queries by capturing contextual and conceptual meanings. Interfaces of the context ingestion system can include a user-friendly interface that allows easy query input and access to data context engine output, selection of a prioritized or standard ingestion process, application programming interface (API) integrations that enable seamless connections with other organizational systems, and visualization tools that support presenting the generated insights in digestible formats.

In operation, in a first example implementation, a query from an artificial intelligence (AI) agent is accessed that includes a request to ingest associated context data with priority, using resources of a scalable pipeline to ingest the context data. When content, such as the context data, is ingested with priority, using resources of a scalable pipeline, the priority ingestion of the content takes precedence over other (for example, standard) content ingestion. In particular, priority ingestion, when requested, causes resources of a computing system to be assigned to the priority ingestion pipeline rather than to other ingestions and, because this pipeline is scalable, the computing system can assign resources as needed to ingest the content and make it available in near real-time (or sooner than standard content ingestion). Accordingly, based on the query, documents that include the contextual data are uploaded and concurrently processed to identify semantic and/or lexical elements of the document using the scalable pipeline. These semantic and/or lexical elements (referred to herein as semantic content) are analyzed to store an index of the document that indicates locations within the document of the identified semantic context. The indices of the semantic and/or lexical elements are content-specific information that helps manage and retrieve contextually relevant information by understanding the relationships between different forms of words and data points. The document and the index are then provided to a shared data access system. From here, the AI system can use the document and the index in the shared data access system to generate a contextually relevant response to the query. In some aspects, other computing systems can also use the document and the index in the shared data access system to reference aspects of the ingested document.

The index is a comprehensive index that includes both identification of the semantic content within the document as well as other data and/or metadata about the document. The context for the query is derived from the index and the document so that language models can generate contextually relevant response to the queries. In some aspects, the query is reframed by the AI system or an agent thereof to rewrite the query to generate an updated version of the query that includes the context (for example, a query from a user of the form “generate a description of the state of current research in this field based on these fifty recent articles” can be rewritten to be something more like “generate a summary for article 1 with index 1, generate a summary for article 2 with index 2, . . . , etc., and then summarize the articles to generate a description of the state of current research based on those summaries”). This updated query can then be used by the language model to generate a response, and the AI system can communicate the response back to the user.

This first example implementation prioritizes content ingestion (for example, uploading, parsing, vectoring, indexing, enriching, and storing contextual data) using the parallel and/or distributed semantic indexing pipeline, based on a request for priority ingestion. In an illustrative example, a user prompts a LLM to summarize several documents to be used for context for a query with priority ingestion. The priority ingestion process will prioritize the upload of the documents by making a declarative event in the existing document upload queue to prioritize document upload and indexing. One example method of prioritizing the document upload and indexing includes removing static limits on uploading (for instance, as explained in connection with FIG. 9) and vectoring the index in the underlying data framework.

As used herein, removing static limits on uploading and vectoring the index includes removing limits on concurrency by, for example, removing restrictions on the amount of computing system resources that are allocated to uploading and vectoring so that, for example, a larger number of threads or processors can be used to upload and vector the index. In some aspects, removing static limits on uploading and vectoring the index also includes removing restrictions on the size of documents that can be uploaded and processed, either with respect to the sum total size of the documents or the size of individual documents. It should be understood that “removing” static limits also includes reducing static limits so that a set limit on resources or size can either be reduced or removed entirely in order to prioritizing document upload and vectoring the index in the underlying data framework.

In a second example implementation, an artificial intelligence (AI) agent is created. When the AI agent receives a query that references a set of documents containing contextual data and a request to ingest the documents with priority, using resources of the scalable pipeline, the AI agent requests priority ingestion of the documents, storing the documents and an index of each of the documents in a shared data access system. The AI agent then provides a query to the AI system that references the documents, the AI system generates a response to the query, and the response is communicated back to the AI agent. As described above, the response is generated based on the context associated with the query, an updated query associated with the context, and a contextual response generation model. In some aspects, display of the response to the query by the AI agent is caused. As with the first example implementation, the second example implementation prioritizes content ingestion (for example, uploading, parsing, vectoring, indexing, enriching, and storing contextual data) using the parallel and/or distributed semantic indexing pipeline, based on user requests for priority ingestion. In the second embodiment, the user indicates to the AI agent that the contextual data is to be ingested with priority, prioritizing the upload of the document by making a declarative event in the existing document upload queue to prioritize the document upload and indexing by removing static limits on uploading and vectoring the index in the underlying data framework.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIG. 1 is a block diagram illustrating an example computing system including a content ingestion system, in accordance with aspects of the technology described herein;

FIG. 2 is a block diagram illustrating high-level data flow of a content ingestion system, in accordance with aspects of the technology described herein;

FIG. 3 is a block diagram illustrating priority content ingestion in a content ingestion system, in accordance with aspects of the technology described herein;

FIG. 4 is a flow diagram illustrating operations of priority content ingestion in a content ingestion system, in accordance with aspects of the technology described herein;

FIG. 5 is a flow diagram illustrating a first example method of performing priority content ingestion using a content ingestion system, in accordance with aspects of the technology described herein;

FIG. 6 is a flow diagram illustrating a second example method of performing priority content ingestion using a content ingestion system, in accordance with aspects of the technology described herein;

FIG. 7 is a block diagram illustrating data flow of update operations for priority content ingestion in a content ingestion system, in accordance with aspects of the technology described herein;

FIG. 8 is a block diagram illustrating data flow of update operations with optical character recognition for priority content ingestion in a content ingestion system, in accordance with aspects of the technology described herein;

FIG. 9 is a block diagram illustrating data flow for primary ingestion using priority content ingestion in a content ingestion system, in accordance with aspects of the technology described herein;

FIG. 10 is a block diagram illustrating asynchronous and synchronous data flow during priority content ingestion in a content ingestion system, in accordance with aspects of the technology described herein;

FIG. 11 is a block diagram illustrating an exemplary computing system suitable for use in implementing aspects of the technology described herein;

FIG. 12 is a block diagram illustrating an exemplary distributed computing environment suitable for use in implementing aspects of the technology described herein; and

FIG. 13 is a block diagram illustrating an exemplary computing environment suitable for use in implementing aspects of the technology described herein.

### DETAILED DESCRIPTION

### Overview

An artificial intelligence (AI) system is a platform designed to perform tasks that typically require human intelligence, such as understanding language, recognizing patterns, and making decisions, often through learning from data. In particular, an AI system can analyze large datasets to identify trends and provide insights that assist in strategic planning. An AI system can be a type of AI agent (for example, such as an AI assistant, including AI assistants like Microsoft® COPILOT, IBM Watson Assistant, Salesforce Einstein, OpenAI ChatGPT, and Rasa) that can be deployed in a computing environment to receive queries and provide responses to such queries. By way of illustration, an AI-based digital assistant uses artificial intelligence techniques like natural language processing and machine learning to understand and respond to user queries. When a user submits a question, the assistant processes the language to interpret the intent, retrieves relevant information from its knowledge base or external sources, and generates a coherent, contextually appropriate response in natural language. This enables the assistant to provide accurate and helpful information or perform tasks efficiently, mimicking human-like interaction.

Conventionally, AI systems are not configured with a comprehensive computing logic and infrastructure to efficiently and effectively respond to queries with specific context data having specific context. Traditional fine-tuning and retrieval-augmented generation (RAG) methodologies for information retrieval in large language models (LLMs) exhibit significant limitations when it comes to interpreting user queries with specific context. One major challenge is the complexity of contextual data, which can be large, complex, and can often contain redundant or extraneous data. Context information on specific topics is frequently fragmented across various sources, making it difficult for models to synthesize coherent responses. This dispersal complicates the retrieval process, as the same content may be rephrased or presented in multiple formats across different documents and databases. The complexities of the context information can cause considerable slowdowns when ingesting contextually relevant data, with the standard ingestion process being performed asynchronously over several minutes, hours, or even days.

Additionally, the effectiveness of post-training processes depends on carefully designed methodologies that can integrate new knowledge while preserving the model's foundational language capabilities. Inadequate approaches can lead to catastrophic forgetting, where the model loses previously acquired knowledge, or result in a general degradation of performance across various tasks. This highlights the necessity for tailored approaches that maintain the integrity of the model while infusing it with specialized knowledge. Inadequate approaches can also lead to hallucinations by the AI system, where incorrect responses are generated due to the lack of foundational knowledge provided by the contextual data.

These limitations underscore the need for more context-aware retrieval methodologies that align model outputs with the unique requirements and operational frameworks of specific queries and the ingestion of contextual information to inform those queries. While RAG demonstrates reasonable efficacy in extracting relevant information when provided with well-structured queries, its performance is often hampered by the delay in ingesting contextual information that is used to inform responses to the queries. Existing literature, although somewhat lagging behind state-of-the-art advancements, supports the notion that flawed recipes can significantly impair model performance. Advancing the capabilities of LLMs to incorporate specific contexts necessitates innovative strategies that enhance context integration, optimize query formulation, and refine post-training methodologies to ensure robust and reliable performance. As such, a more comprehensive AI system-with an alternative basis for performing contextual response generation-can improve computing operations and interfaces for artificial intelligence systems.

### Description of Technical Solution

At a high level, a content ingestion system is a component of a computing system, including scalable and/or distributed systems, that receives and processes context used to provide context for responses to queries made to an AI system such as a large language model (LLM). Input to a context ingestion system is typically in the form of documents and can include documents, emails, chats, multimedia content, and system originated and/or external content, as described herein. As used herein, documents can include any content that can be used to provide content and can include, without limitation, text, images, video, audio, web-based links (for example, a uniform resource locator), and/or other such content. A content ingestion system receives the documents, processes the content to identify semantic and/or lexical elements in the documents, generates an index of the content indicating the presence of and/or location of the semantic content within the document, generates other metadata related to the document, and provides the document, the index, and/or the metadata to a shared data access system for use by other components of the computing system including, but not limited to, the AI system.

In some aspects, the shared data access system can be used by a contextual response model, which is an element of an AI system. The contextual response model can specifically be a machine learning model with an extended context window that facilitates incorporating the ingested context for responding to queries. A contextual response system can be an artificial intelligence (AI) response generation service that can leverage AI in various ways to provide enhanced functionality and provide users with advanced tools and features to process queries and produce contextually accurate responses based on processing the queries. The contextual response system can support integrating context with user queries to generate contextually accurate responses to user queries. The contextual response system can leverage various AI tools, such as machine learning models, language models (such as LLMs or small language models), and retrieval-augmented generated (RAG) models, in various ways to provide enhanced functionality and provide users with contextually accurate responses to queries.

By way of context, language models, such as LLMs, have transformed the landscape of natural language processing by enabling sophisticated reasoning over extensive corpora and complex tasks. Traditionally, two primary methodologies have been employed for this purpose: retrieval-augmented generation (RAG) and fine-tuning. However, recent advancements in LLM architectures (for example, extension of context windows) can support a technical solution focused on optimizing the use of a contextual framework provided by a content ingestion system. As described above, content ingestion can be performed asynchronously so that, for example, content is uploaded when requested, but processing of the documents of the content can be delayed or performed asynchronously.

In an illustrative example, consider context embodied in a corpus of related documents that, together, comprise fifty documents and several hundred gigabytes (GB) of data. Processing these documents to extract the semantic content, generate the index, and/or generate other metadata can require a significant amount of computational resources. In some aspects, processing the documents also generates a “summary” of the document that is a high-level, human-readable distillation of the ingested document. This summary can be included in the index, in the other metadata, or in some other such data store. Extracting the semantic content typically requires analysis of the document using various language models, generating the index using other language models, and generating other metadata for the document, which can require other systems including, but not limited to, still more language models. Techniques such as natural language summarization and entity recognition are employed to distill pertinent semantic and/or lexical elements while filtering out extraneous “filler” language often present in human communications. The outcome is an index that enhances the relevance and interpretability of user queries by providing LLMs with critical context. Performing this processing asynchronously (for example, in a delayed manner) can more efficiently use computational resources and delay the content ingestion to a later time when, for example, there is less demand on the computational systems and the resources thereof. However, the cost of performing the content ingestion asynchronously is that the content, and thus the context, will not be immediately available for use by a contextual response model to generate responses to a query. A user with a high-demand query may find it unacceptable to receive a response to a query hours, or even days, later.

Embodiments described herein are for a content ingestion system that incorporates prioritized content ingestion to provide synchronous ingestion of content, thereby allowing near real-time responses to queries that rely on context embodied by the ingested content. As used herein, prioritized content ingestion is an alternate method for ingesting content in a content ingestion system that, upon determining that content is to be ingested with priority (which may be based on a user request), uploads and concurrently processes the documents, using priority access to computer system resources. Priority content ingestion uses a number of data flows, described herein, to process documents as they are uploaded to identify semantic and/or lexical elements, generate an index, generate metadata, generate a summary, and provide this data to a contextual response generation system for immediate use in using context to respond to a query. When priority ingestion is requested, the uploading and indexing of the contextual data is given priority over other ingestion operations (for example, those of lower or standard priority) by providing additional resources, and by making a declarative event in the document upload queue to remove static limits on uploading and vectoring the index in the underlying data framework.

Once the context is generated, it is strategically utilized in multiple stages of a contextual response generation (for example, a contextual response generation service). Initially, user queries are enhanced by integrating the context, which enriches the queries with the ingested contextual information. This enhancement facilitates a deeper understanding of the user's intent, allowing the model to rewrite simple queries to more complex queries that integrate the context and thus, are better able to provide more relevant responses. By incorporating the contextual information obtained by priority content ingestion, a contextual response generation model can generate responses that are not only accurate but also contextually relevant in near real-time. This approach significantly improves the quality of the responses, providing users with answers that are more nuanced and aligned with their inquiries. This approach also allows users to perform contextually informed queries, receive responses, update the queries, and iteratively improve the quality of responses.

The process of using the content ingestion system to perform priority content ingestion (also referred to herein as “prioritized content ingestion” and/or “rapid content ingestion”) begins with a user request. The user request can include a query, documents that provide the context for the query, and a request that the content ingestion be performed using priority content ingestion. For instance, a user can submit a query to “generate a description of the state of current research in this field based on these fifty recent articles” and request that the query be processed using priority content ingestion. The first step would be to begin uploading the fifty articles to the content ingestion system and, based on the request for priority ingestion, invoke priority content ingestion to concurrently (for example, synchronously) process each of the documents (for example, to determine semantic and/or lexical elements of the documents, generate an index, generate metadata, and/or generate a summary) as they are uploaded. As described herein, prioritizing content ingestion uses computing system resources to remove static limits on uploading and vectoring the index in the underlying data framework, as described below. A query that does not include a request that the content ingestion be performed using priority content ingestion might be performed using standard content ingestion that may result in delaying the processing of the documents until a later time. In some instances, resources used to perform this delayed processing with standard ingestion are repurposed to perform a priority ingestion so that the standard ingestion operations are further delayed in favor of a priority ingestion. In some aspects, content ingestion is performed using several different priority configurations or settings so that higher priority ingestion is performed before lower priority ingestion and all priority ingestion is performed before standard (for example, asynchronous) ingestion. In such aspects, the highest priority ingestion can have no static limits on uploading and vectoring, lower priority ingestion can have some static limits on uploading and vectoring, and standard ingestion can have the highest static limits on uploading and vectoring. It should be noted that the context embodied in the documents associated with the request can be additional context (for example, additional documents) that can be added to existing context from, for example, previously uploaded and processed documents.

As each document is uploaded, priority content ingestion parses the document to determine semantic and/or lexical elements and saves the results of the parsing in a datastore (for example, a database or some other such data storage system). The priority content ingestion process then submits a request to process the parsed data using express processing so that the index, the metadata, and the summary are generated with high priority. The priority content ingestion process uses high-priority processing to request additional computational resources to perform the parsing and the processing using the scalable and/or parallel pipeline. For example, when a first document (for example, of a set of documents) is being uploaded, a first set of computational resources (for example, processors or threads) can be used to parse the first document and save the parsing data. Then, while a second document is being uploaded, a second set of computational resources can be used to parse that second document and save the parsing data. Meanwhile, a third set of computational resources can concurrently be used to use the saved parsing data of the first document to generate the index, generate any metadata, and/or generate a summary. In this way, at any particular time during ingestion, a plurality of documents can be ingested, limited only by the available computational resources.

As the documents are ingested, data is retrieved from the various sets of computational resources to generate the contextually relevant content for the document (for example, the index, any metadata, and/or a summary of the document), and that content is made available to a shared data access system (for example, a content management system) so that, for example, a contextual response generation system can use the parsed content to provide a contextually relevant response to the query.

In some aspects, the context can be used to amplify the query (for example, generating a rewritten query via a context integrator) using the context of the ingested content that is obtained from the shared data access system (for example, the index, the metadata, and/or the summary). In some aspects, the ingested content can be used by other systems (for example, email systems or other web-based systems) that can access the shared data access system. Finally, a contextually informed response to the query can be provided to the user in near real-time (for example, without a significant delay caused by asynchronous ingestion of the content).

In general, systems and methods described herein provide the ability to parse, vector, enrich, index, and store user documents for use in AI application. Since an AI application needs the context data (for example, the grounding data) as described herein, the priority content ingestion processes described herein can provide that context data several orders of magnitude faster than with standard ingestion, providing the context data to computer systems in a faster and more efficient manner.

In this way, the priority content ingestion approach addresses several limitations inherent in current methodologies. For instance, while typical language models can be effective at retrieving information when provided with precise queries within the scope of the language model, they can struggle in scenarios where considerable context is required for the query. Not having the context can also cause incorrect or misleading responses to be generated. Given that context improves query responses, particularly for general language models, the problem of providing that context to the language model becomes paramount. Priority content ingestion reduces the considerable lag that can occur, particularly with many documents or with very large and complex documents, thereby improving a better user experience and a more effective framework for developing insights related to queries. Priority content ingestion also reduces computational resources and improves the efficiency of the resources used. In priority content ingestion, the ingestion is direct, using a parallel and/or distributed semantic indexing pipeline. This minimizes costly data transport between processes that may be executed asynchronously at different times and on different systems.

Priority content ingestion represents a significant advancement in enhancing the capabilities of LLMs for interpreting user queries and generating contextually relevant responses. By quickly analyzing and processing content to determine semantic and/or lexical elements and to provide an index of those elements, a priority context ingestion system can combine and organize extensive amounts of information and provide the context to various systems in near real-time. This approach enables LLMs to, for example, process user requests with greater speed, accuracy, and relevance. Furthermore, by facilitating real-time updates to the context, the methodology offers a better user experience, a faster response time, and a more efficient use of computational resources.

Advantageously, the embodiments of the present technical solution include several inventive features (for example, operations, systems, engines, and components) associated with an artificial intelligence system having a priority content ingestion system. The priority content ingestion system supports identifying, curating, and synthesizing context from input content, and further supports generating a contextually accurate response to queries using a contextual response generation engine. The contextual response generation engine can support integrating context with user queries to generate contextually accurate responses to user queries and, since the context is available sooner, a user can quickly build up a context-aware AI agent to generate hypotheses and fine-tune responses that are contextually relevant. In particular, the contextual response generation engine may leverage AI in various ways to provide enhanced functionality and provide users with contextually accurate responses to queries that are context-specific. For example, a user can provide a query with contextually relevant content, ingest that content, and begin to use the derived context to generate a plurality of finer-tuned queries based on the ability to utilize the context. Hence, the responses that are generated by a language model are much better (for example, more contextually accurate) and can be quickly obtained.

### Example Systems and Resources

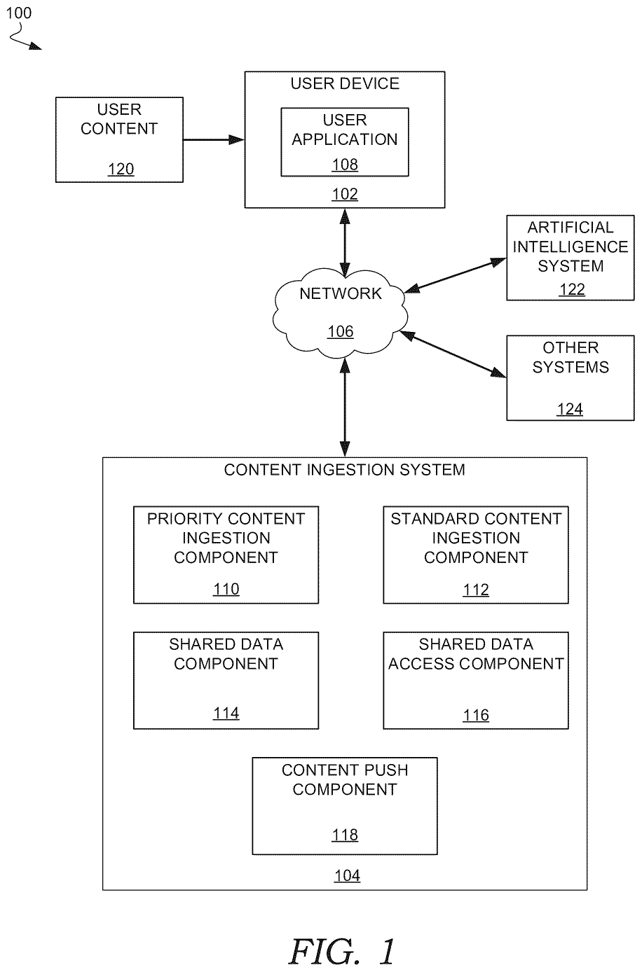

Aspects of the technical solution can be described by way of examples and with reference to FIGS. 1-4. FIG. 1 is a block diagram 100 illustrating an example computing system including a priority content ingestion system, in accordance with aspects of the technology described herein. It should be understood that this and other arrangements described herein are set forth only as examples. Other arrangements and elements (for example, machines, interfaces, functions, orders, and groupings of functions, etc.) are used in addition to or instead of those shown, and some elements are omitted altogether. Further, many of the elements described herein are functional entities that are implemented as discrete or distributed components or in conjunction with other components, and in any suitable combination and location. Various functions described herein as being performed by one or more entities are carried out by hardware, firmware, and/or software. For instance, various functions are carried out by a processor executing instructions stored in memory.

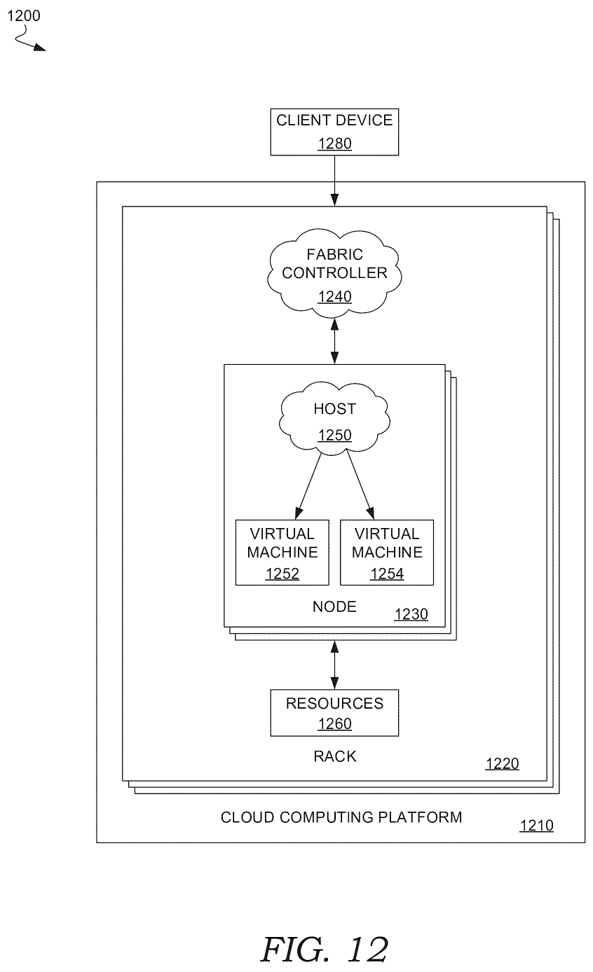

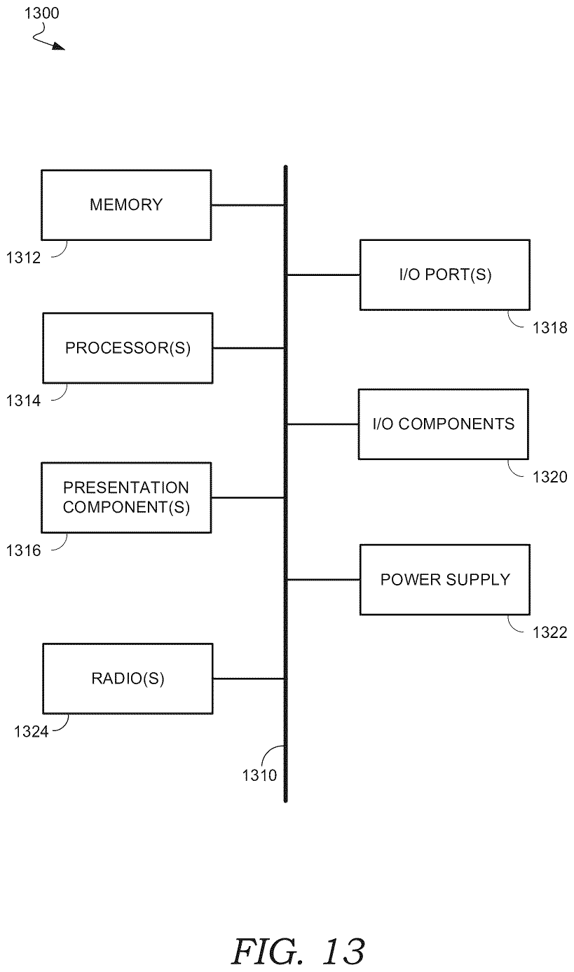

The system illustrated in block diagram 100 is an example of a suitable architecture for implementing certain aspects of the present disclosure. Among other components not shown, the system illustrated in block diagram 100 includes a user device 102, a content ingestion system 104, a network 106, an artificial intelligence system 122, and one or more other systems 124. Each of the user device 102, the content ingestion system 104, the artificial intelligence system 122, and the one or more other systems 124 shown in FIG. 1 can comprise one or more computer devices, such as the computing device 1300 of FIG. 13, described below. Additionally, each of the user device 102, the content ingestion system 104, the artificial intelligence system 122, and the one or more other systems 124 can be elements of a cloud computing platform 1210 of FIG. 12, also described below.

As shown in FIG. 1, the user device 102, the content ingestion system 104, the artificial intelligence system 122, and the one or more other systems 124 can communicate via a network 106, which may include, without limitation, one or more local area networks (LANs) and/or wide area networks (WANs). Such networking environments are commonplace in offices, enterprise-wide computer networks, intranets, and the Internet. It should be understood that any number of user devices and servers may be employed within the system illustrated in block diagram 100 within the scope of the present technology. Each device or server may comprise a single device or multiple devices cooperating in a distributed environment. For instance, the content ingestion system 104 may be provided by multiple server devices collectively providing the functionality of the content ingestion system 104, as described herein. Additionally, other components not shown may also be included within the environment.

As illustrated in FIG. 1, the user device 102 is a client device on the client-side of the operating environment illustrated in block diagram 100, while the content ingestion system 104, the artificial intelligence system 122, and the one or more other systems 124 are on the server-side of the operating environment illustrated in block diagram 100. In some aspects, the content ingestion system 104, the artificial intelligence system 122, and the one or more other systems 124 comprise server-side software designed to work in conjunction with client-side software on the user device 102 so as to implement any combination of the features and functionalities discussed in the present disclosure. For example, the user device 102 can include a user application 108 for interacting with the content ingestion system 104 via the network 106. The application 108 is, for instance, a web browser or a dedicated application for providing functions, such as those described herein. As may be contemplated, this division of an operating environment illustrated in block diagram 100 is provided to illustrate one example of a suitable environment. There is no requirement for each implementation that any combination of the user device 102 and the content ingestion system 104 remain as separate entities. While the operating environment illustrated in block diagram 100 illustrates a configuration in a networked environment with a separate user device 102 and content ingestion system 104, it should be understood that other configurations can be employed in which aspects of the various components are combined together in different arrangements. For instance, aspects of the content ingestion system 104 can be implemented in part or in whole by the user device 102.

In some configurations, the application 108 can comprise a user interface (not shown in FIG. 1). In some configurations, the user interface provides access to the content ingestion system 104, the artificial intelligence system 122, or the one or more other systems 124 to a user of the user device 102. In some instances, the user interface is presented on the user device 102 via the application 108, which is a web browser or a dedicated application for interacting with the content ingestion system 104, the artificial intelligence system 122, or the one or more other systems 124. In an illustrative example, the user interface can provide user interfaces for, among other things, receiving input from a user and providing responses to the user. It should be noted that, while the user interface is described as an element of application 108, in some embodiments, the content ingestion system 104 further includes a user interface component (not shown in FIG. 1) that provides one or more user interfaces for interacting with the content ingestion system 104. In some aspects, not shown in FIG. 1, a user interface component provides one or more user interfaces to a user device, such as the user device 102 via the application 108.

The user device 102 may comprise any type of computing device capable of use by a user. For example, in one aspect, a user device may be the type of computing device 1300 described in relation to FIG. 13 herein. By way of example and not limitation, the user device 102 may be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device. Although not shown in FIG. 1, a user may be associated with the user device 102 and may interact with the content ingestion system 104, the AI system 122, and/or the one or more other systems 124 via the user device 102.

In some configurations, the content ingestion system 104 may be implemented, at least in part, using artificial intelligence models that generate responses to user queries through natural language interaction. In such instances, the content ingestion system 104 can use artificial intelligence and machine learning algorithms to understand user queries, process data related to those queries, and provide responses by accessing relevant information from various sources such as the AI system 122 or the one or more other systems 124. In at least one embodiment, the content ingestion system 104 uses language models such as those described herein to understand user queries, process data related to those queries, and provide responses using systems, methods, operations, and techniques such as those described herein.

As described herein, the content ingestion system 104 performs operations to perform priority content ingestion based on a user request (for example, from a user application 108). Based on the request, the content ingestion system uploads the documents, processes the documents to determine semantic and/or lexical elements of the documents, generates an index of the semantic and/or lexical elements within each of the documents, optionally generates metadata about each of the documents and/or a summary of the documents, and further processes this index to generate contextually relevant information about the documents. In an embodiment where the content ingestion system 104 uses standard ingestion, the content ingestion system 104 performs these operations asynchronously (for example, using delayed processing). In an embodiment where the content ingestion system 104 uses priority ingestion (as described herein), the content ingestion system 104 performs these operations synchronously (for example, in real-time). As described herein, standard ingestion using asynchronous processing can take hours or even days, while priority ingestion using synchronous processing can take seconds. This represents a multiple order of magnitude improvement in ingesting content.

As shown in FIG. 1, the content ingestion system 104 comprises a priority content ingestion component 110, a standard content ingestion component 112, a shared data component 114, a shared data access component 116, and/or a content push component 118. The components of the content ingestion system 104 are in addition to other components that provide further additional functions beyond the features described herein. The content ingestion system 104 is implemented using one or more server devices, one or more platforms with corresponding application programming interfaces, cloud infrastructure, and the like. While the content ingestion system 104 is shown as separate from the user device 102 in the configuration of FIG. 1, it should be understood that in other configurations, some or all of the functions of the content ingestion system 104 are provided on the user device 102. Additionally, in some configurations, one or more of the components of the content ingestion system 104 shown in FIG. 1 (for example, the priority content ingestion component 110, the standard content ingestion component 112, the shared data component 114, the shared data access component 116, and/or the content push component 118) are provided by the user device 102 and/or other devices not shown in FIG. 1. In some configurations, the components of the content ingestion system 104 are provided by a single entity or by multiple entities.

As described above, to facilitate interaction with users, the user application 108 incorporates a user interface that allows for easy query input and access to generated responses. This interface can also display contextual data and insights extracted during the content ingestion process, promoting better user engagement. Furthermore, application programming interface (API) integrations allow for seamless connections with other organizational systems (for example, AI system 122 and/or other systems 124), enabling the content ingestion system 104 to derive relevant data dynamically and push generated insights back into user workflows. In some aspects, visualization tools are used to present the determined contexts and associated responses in easily digestible formats, such as dashboards or visual reports, helping users quickly comprehend complex information and derive actionable insights.

In some aspects, the content ingestion system 104 provides a service process (for example, priority content ingestion 302) that is integrated into an enterprise computing environment associated with a plurality of data sources. The content ingestion system 104 comprises elements of a context generation system that programmatically transforms the ingested data into usable contexts. In such systems, the shared data access component 116 acts as the entry point for information including gathering data from a wide range of data sources. In some aspects, context generation can employ Named Entity Recognition (NER) algorithms to identify and classify key entities within user content 120. In some aspects, the content ingestion system 104 processes the content through large language models (LLM), using the LLM to extract semantic content, as described above. In such aspects, an LLM's capabilities enable it to synthesize information from multiple sources, producing a narrative that captures the essence of the input data while maintaining technical accuracy.

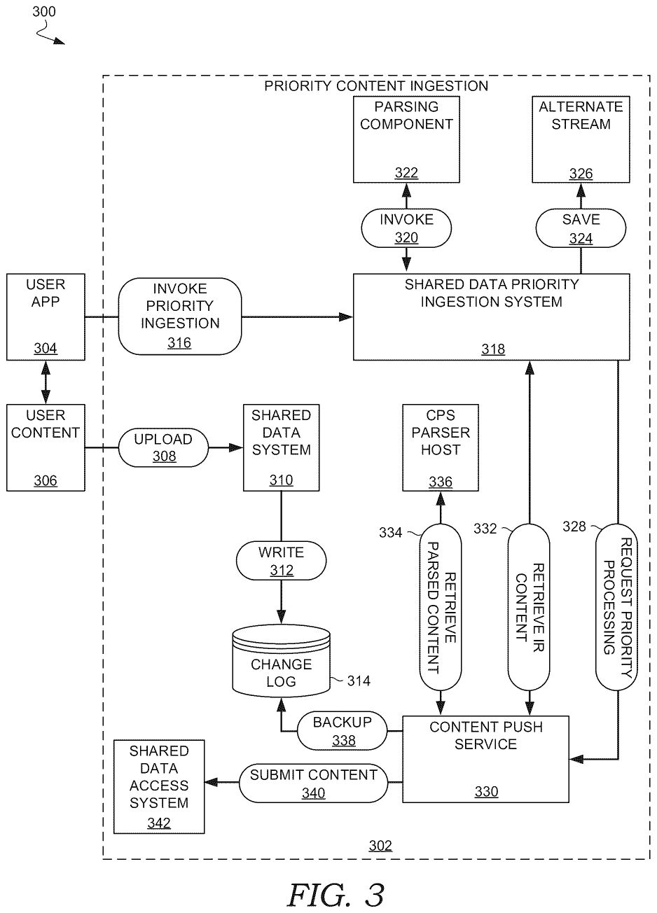

Given input from user application 108 (for example, using user device 102) that includes a query to an AI system such as AI system 122 and context for the query contained in user content 120, the content ingestion system 104 begins uploading the user content 120 via network 106 for ingestion. If the input includes a request to ingest the user content 120 with priority (for example, with an indication that the content is to be ingested using the scalable parallel and/or distributed semantic pipeline to upload, parse, vector, index, enrich, and store contextual data), the content ingestion system 104 uses a priority content ingestion component 110 to synchronously ingest the user content 120 (for example, to process the files to determine semantic content, generate indices, generate metadata, and/or generate summaries of the user content 120), as described below at least in connection with FIGS. 3-7. If the input does not include a request to ingest the user content 120 with priority, the content ingestion system 104 can use a standard content ingestion component 112 to asynchronously ingest the user content 120 (for example, to process the files to determine semantic content, generate indices, generate metadata, and/or generate summaries of the user content 120).

Given the request, the content ingestion system 104 uses the shared data component 114 to receive the files and, depending on whether the request includes a request to ingest the user content 120 with priority, the content ingestion system uses either the priority content ingestion component 110 or the standard content ingestion component to process the files (for example, to process the files to determine semantic content, generate indices, generate metadata and/or generate summaries of the user content 120). When the request does include a request to ingest the user content 120 with priority, the content ingestion system 104 uses priority content ingestion 302, described at least in connection with FIG. 3 to ingest the user content 120 with priority. As the content (for example, the user content 120) is processed, the content ingestion system 104 uses a content push component 118 to provide the processed content to a shared data access component 116.

Although the shared data access component 116 is illustrated as part of the content ingestion system 104, in some aspects the shared data access component 116 is a separate entity that can be used by a variety of systems (for example, the artificial intelligence system 122 and/or one or more other systems 124) of the operating environment illustrated in block diagram 100.

Additionally, while requests to ingest the user content 120 with priority are described herein in connection with a query to an AI system (for example, AI system 122), requests to ingest user content 120 with priority can also be associated with requests to other systems (for example, other systems 124) and can also be standalone requests to ingest user content 120 with priority and store the ingested content so that it can be provided by a shared data access component 116 for later use.

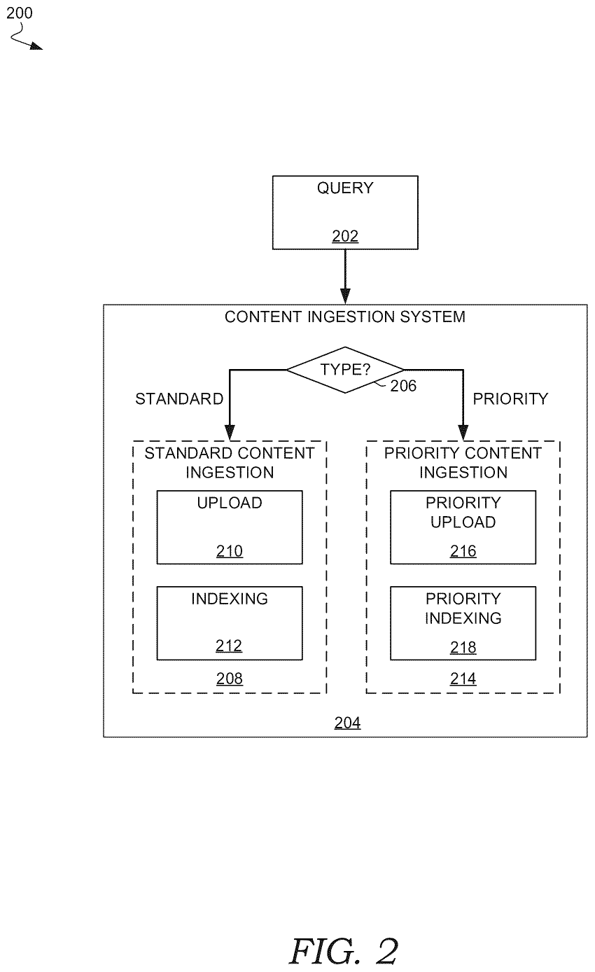

FIG. 2 is a block diagram 200 illustrating high-level data flow of a content ingestion system, in accordance with aspects of the technology described herein. A query 202 to a content ingestion system 204 can include a request to ingest content with priority, as described above. When the content ingestion system 204 receives the query 202, the content ingestion system first determines whether the query includes a request to ingest the content with priority or not. If the type 206 of ingestion of the query 202 is not for priority ingestion, the content ingestion system 204 uses standard content ingestion 208 to upload 210 and perform indexing 212 on the content associated with the query 202 (for example, asynchronously). If the type 206 of ingestion of the query 202 is for priority ingestion, the content ingestion system 204 uses priority content ingestion 214 to do a priority upload 216 of the content and to perform priority indexing 218 of the content associated with the query 202 (for example, synchronously), as described at least in connection with FIG. 3. The type 206 of ingestion associated with the query 202 can be specified by the user using an API (for example, that includes the query 202) or can be specified using a user interface such as those described herein.

In one embodiment, an API to enable priority content ingestion can receive, as input one or more parameters including but not limited to, a uniform resource indicator (URI) that specifies the location of the shared data system (for example, as described below), a flag to enable or disable priority content ingestion, an optional file limit on the number of files to be processed during the content ingestion, a flag indicating whether the shared data system is to perform continuous priority ingestion, and a flag forcing priority processing (for example, by a content push service) of the shared data system. In some aspects, an API to enable priority content ingestion can return one or more indications of success or failure.

FIG. 3 is a block diagram 300 illustrating priority content ingestion 302 in a content ingestion system, in accordance with aspects of the technology described herein. When a user application 304 (for example, user application 108) performs a request to ingest content with priority, embodied in user content 306, the priority content ingestion 302 performs a priority upload 308 of the user content 306 to a shared data system 310. In an aspect, the shared data system 310 is a shared data system such as SharePoint Online® (SPO) by Microsoft®, Google Workspace, and Dropbox Business. When the priority upload 308 of the user content 306 to the shared data system 310 is performed, the shared data system 310 performs a write 312 to a change log 314, recording the priority upload 308. A write 312 to the change log 314 stores data and/or metadata that describes a user or system operation (for example, if a user creates a new SPO site, an event will be written change log 314 indicating this action).

While the priority upload 308 is being performed, the user application 304 invokes priority content ingestion 316 using a shared data priority ingestion system 318 which is a system that facilitates priority ingestion of user content 306. Invoking priority content ingestion 316 uses a signal from user application 304 to a content or source database. This signal is used as an indicator to process upload events with priority that are stored in change log 314, which triggers priority ingestion. When the shared data priority ingestion system 318 performs the priority ingestion, it will first generate an intermediate representation of the content as described below and, if successful, will set an indication that the user file has an intermediate representation.

To perform the priority content, the shared data priority ingestion system 318 first invokes 320 a parsing component 322 that performs media transformation and analytics to parse the user content 306 to identify semantic and/or lexical content within the user content 306. The shared data priority ingestion system 318 then saves 324 the results of the parsing (for example, from the parsing component 322) in an alternate stream 326. The alternate stream 326 caches parsed content of the uploaded user content, thereby reducing the ingestion time later in the process as the parsed content is retrieved from a local cache instead of generated on demand.

The shared data priority ingestion system 318 then sends a request to perform priority processing of the results of the parsing to a content push service 330, which is a service that typically asynchronously crawls through parsed data of the user content 306 to determine the semantic content. In the example illustrated in FIG. 3, where priority content ingestion is performed, the content push service synchronously crawls through the parsed data of the user content 306 to determine the semantic content using high-priority processing so that the semantic content can be generated for each of the user content 306 as they are uploaded.

The content push service 330 then retrieves IR content 332 from the shared data priority ingestion system 318. As used herein, IR content 332 is an intermediate representation of the content. In order to parse and ingest user content with priority, the content push service 330 needs to use a high-fidelity format of the content that is referred to as IR content 332. In some aspects, a file that has an intermediate representation has an indication that the IR content is available. For a file that has IR content 332, the content push service 330 can retrieve the IR content 332 from the shared data priority ingestion system 318.

The content push service 330 next retrieves the parsed content 334 (for example, the results of the parsing) from a content push service parser host (CPS host 336). The content push service 330 is a service that crawls content locations, parses content, and pushes all the user generated content; it also assigned the appropriate content access control for each file. The content push service 330 verifies and confirms input. The CPS host 336 stores such data for later access by other systems.

Finally, the content push service 330 performs a backup 338 to the change log 314 (for example, stores a backup event) and submits the content 340 to a shared data access system 342, which is a shared data access system (SDAS) used by other computing systems (for example, AI systems and/or other systems) to access the context derived from the user content 306. In some embodiments, not shown in FIG. 3, a plurality of threads are used to implement aspects of priority content ingestion 302 so that, as each file of user content 306 is uploaded, various steps of priority content ingestion 302 are performed concurrently and/or in parallel.

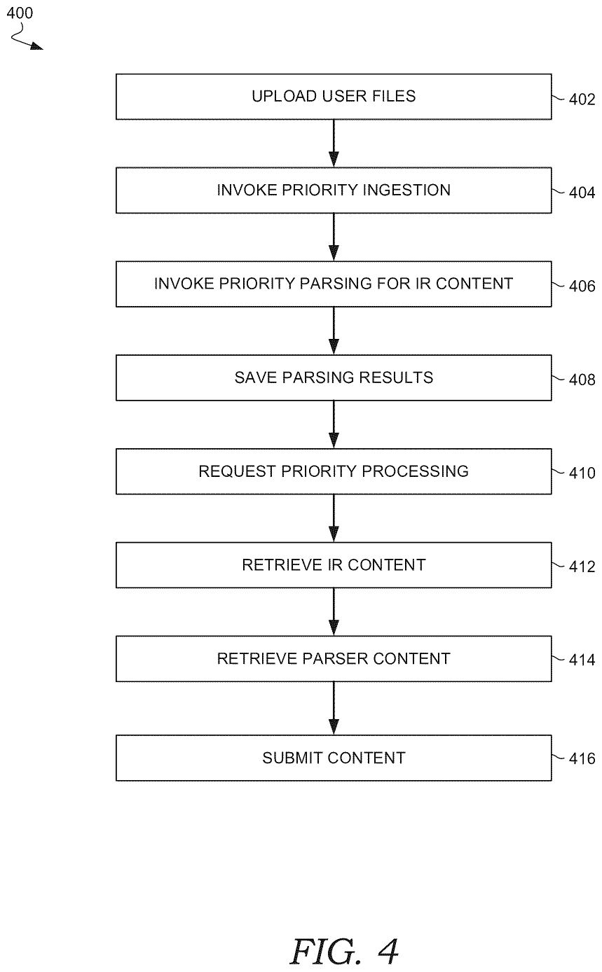

FIG. 4 is a flow diagram 400 illustrating operations of priority content ingestion in a content ingestion system, in accordance with aspects of the technology described herein. FIG. 4 illustrates one possible order of the operations of priority content ingestion 302, described at least in connection with FIG. 3. As may be contemplated, FIG. 4 illustrates an exemplary order of operations and, as described herein, the operations of priority content ingestion can, and typically are, performed concurrently with each other and also performed concurrently for each of a plurality of user content items.

At block 402, a processor implementing priority content ingestion performs operations to upload user content (for example, to perform a priority upload 308 of user content 306, as described in connection with FIG. 3).

At block 404, a processor implementing priority content ingestion performs operations to invoke priority ingestion (for example, to invoke priority content ingestion 316).

At block 406, a processor implementing priority content ingestion performs operations to invoke priority parsing for the IR content (for example, to invoke 320 a parsing component 322).

At block 408, a processor implementing priority content ingestion performs operations to save the parsing results (for example, to save 324 the results of the parsing to an alternate stream 326).

At block 410, a processor implementing priority content ingestion performs operations to request express processing by a content push service (for example, to request priority processing 328 by the content push service 330).

At block 412, a processor implementing priority content ingestion performs operations to retrieve the IR content (for example, to retrieve the IR content 332 from the shared data priority ingestion system 318).

At block 414, a processor implementing priority content ingestion performs operations to retrieve the parser content (for example, to retrieve the parsed content 334 from the CPS host 336).

At block 416, a processor implementing priority content ingestion performs operations to submit the content (for example, to submit the content 340 to a shared data access system 342).

As may be contemplated, some operations of priority content ingestion are not shown in FIG. 4 including, but not limited to, the operations to write 312 to the change log 314 and the operations to perform a backup 338 to the change log 314.

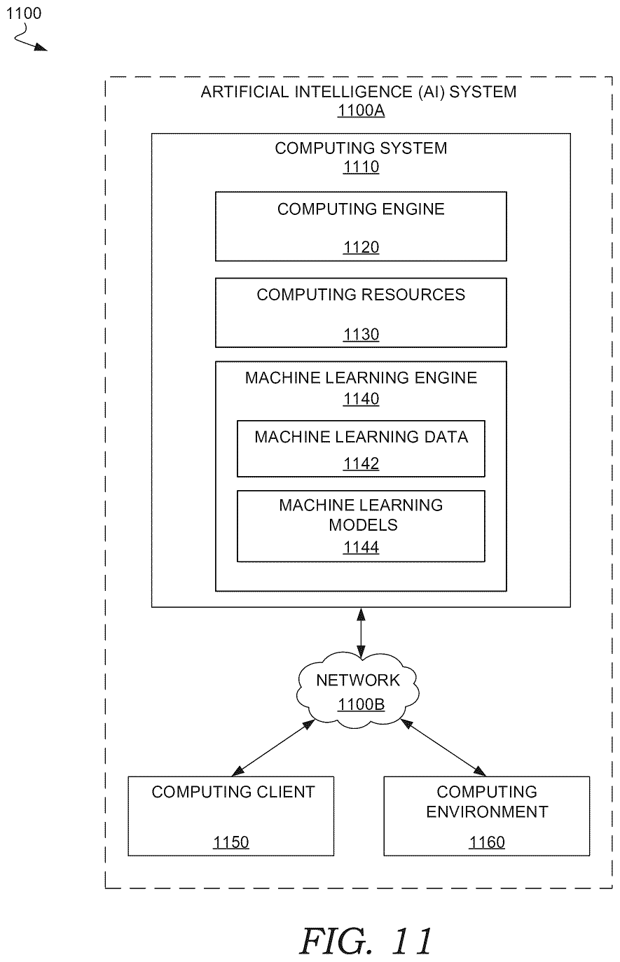

Aspects of the technical solution have been described by way of examples and with reference to FIGS. 1-4 that illustrate an exemplary technical solution environment that can be implemented within example environments described with reference to FIGS. 11, 12, and 13, and aspects of FIGS. 11, 12, and/or 13 can be used to implement embodiments of the technical solution. Generally the technical solution environment includes a technical solution system suitable for providing the example computing system illustrated in block diagram 100 in which methods of the present disclosure may be employed. In particular, FIG. 1 illustrates a high-level architecture of the computing system illustrated in block diagram 100 in accordance with implementations of the present disclosure, and FIG. 3 illustrates details of priority content ingestion 302, also in accordance with implementations of the present disclosure.

### Example Methods

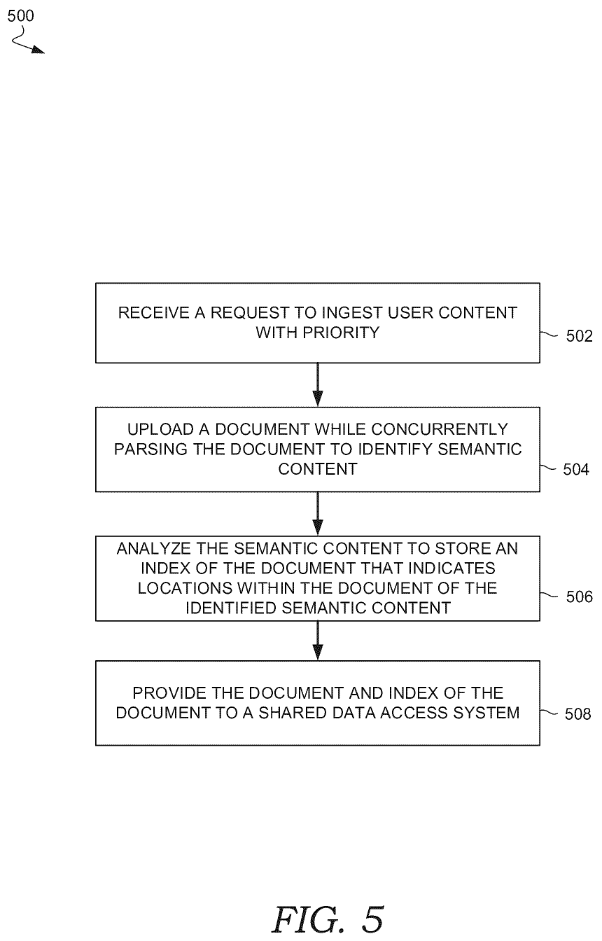

With reference to FIGS. 5, 6, and 7, flow diagrams are provided illustrating methods for performing priority content ingestion using priority content ingestion. The methods may be performed using the content ingestion system 104 described herein. In some embodiments, one or more computer-storage media having computer-executable or computer-useable instructions embodied thereon that, when executed, by one or more processors can cause the one or more processors to perform the methods (for example, computer-implemented method) using the content ingestion system 104.

FIG. 5 is a flow diagram 500 illustrating a first example method of performing priority content ingestion using a priority content ingestion system, in accordance with aspects of the technology described herein. The process (or method) illustrated in FIG. 5 is performed by, for instance, the content ingestion system 104 described herein at least in connection with FIG. 1. Each block of the method illustrated in FIG. 5 and any other methods described herein comprise a computing process performed using any combination of hardware, firmware, and/or software. For instance, various functions are carried out by a processor executing instructions stored in memory. The method or methods can also be embodied as computer-usable instructions stored on computer storage media. The methods are provided by a standalone application, a service or hosted service (standalone or in combination with another hosted service), a plug-in to another product, or other such applications, services, products, or plug-ins.

At block 502, a processing device implementing the present disclosure performs operations to receive a request to ingest user content with priority. As described above, the request to ingest user content can be associated with a query to an AI system (for example, to generate context from the user content that can be used to inform the query), can be associated with a query to one or more other systems, or can be a standalone request (for example, not associated with any query). In some aspects, after block 502, the process illustrated in FIG. 5 continues at block 504.

At block 504, a processing device implementing the present disclosure performs operations to upload the document while concurrently parsing the document to identify semantic content. In some aspects, after block 504, the process illustrated in FIG. 5 continues at block 506.

At block 506, a processing device implementing the present disclosure performs operations to analyze the semantic content to store an index of the document that indicates locations within the document of the identified semantic content (for example, identified at block 504). In some aspects, after block 506, the process illustrated in FIG. 5 continues at block 508.

At block 508, a processing device implementing the present disclosure performs operations to provide the document and the index (for example, stored at block 506) of the document to a shared data access system. In some aspects, after block 508, the process illustrated in FIG. 5 terminates. In some aspects, not shown in FIG. 5, after block 508, the process illustrated in FIG. 5 continues at block 502, to receive a new request to ingest user content with priority. In some aspects, the new request to ingest user content with priority is for a next file in a set of user files. In some aspects, the new request to ingest user content with priority is for a new set of user files.

Although not illustrated in FIG. 5, in some configurations, the operations of the process illustrated in FIG. 5 are performed in a different order than that described. In some configurations, where operations are performed in a different order, some of the operations are performed in parallel by a plurality of devices such as those described herein, using a plurality of threads. As may be contemplated, other orders in which to perform the operations illustrated in flow diagram 500 may be considered as being within the scope of the present disclosure.

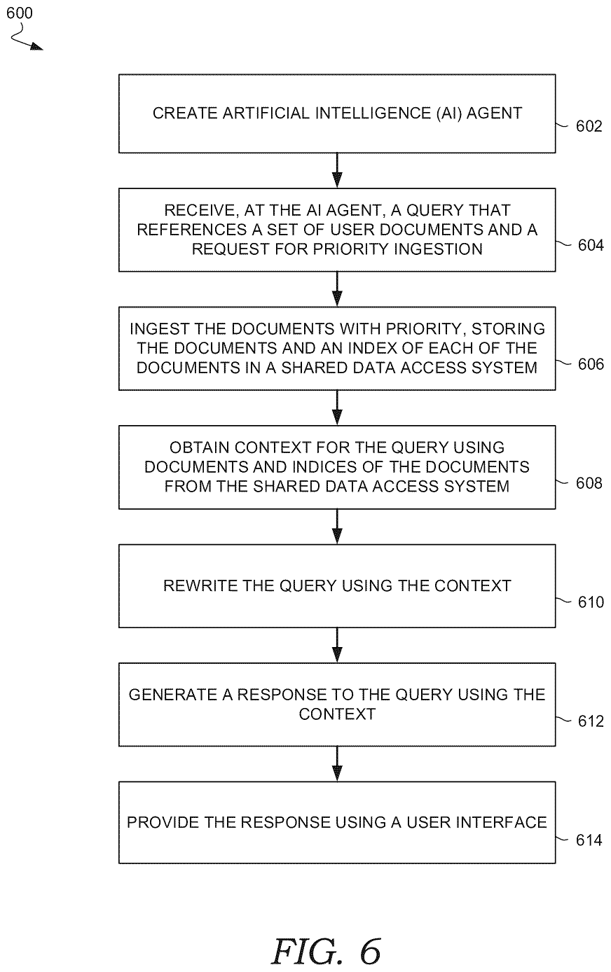

FIG. 6 is a flow diagram 600 illustrating a second example method of performing priority content ingestion using a priority content ingestion system, in accordance with aspects of the technology described herein. The process (or method) illustrated in FIG. 6 is performed by, for instance, the content ingestion system 104 described herein at least in connection with FIG. 1. Each block of the method illustrated in FIG. 6 and any other methods described herein comprise a computing process performed using any combination of hardware, firmware, and/or software. For instance, various functions are carried out by a processor executing instructions stored in memory. The method or methods can also be embodied as computer-usable instructions stored on computer storage media. The methods are provided by a standalone application, a service or hosted service (standalone or in combination with another hosted service), a plug-in to another product, or other such applications, services, products, or plug-ins.

At block 602, a processing device implementing the present disclosure performs operations to create an artificial intelligence (AI) agent. In some aspects, after block 602, the process illustrated in FIG. 6 continues at block 604.

At block 604, a processing device implementing the present disclosure performs operations to receive, at the AI agent (for example, created at block 502), a query that references a set of user documents and a request for priority ingestion. In some aspects, after block 604, the process illustrated in FIG. 6 continues at block 606.

At block 606, a processing device implementing the present disclosure performs operations to ingest the documents with priority, storing the documents and an index of each of the documents in a shared data access system. In some aspects, after block 606, the process illustrated in FIG. 6 continues at block 608.

At block 608, a processing device implementing the present disclosure performs operations to obtain context for the query using the set of user documents and indices of the documents obtained from the shared data access system (for example, stored at block 606). In some aspects, after block 608, the process illustrated in FIG. 6 continues at block 610.

At block 612, a processing device implementing the present disclosure performs operations to rewrite the query using the context (for example, obtained at block 610) as described herein. In some aspects, after block 610, the process illustrated in FIG. 6 continues at block 614.

At block 612, a processing device implementing the present disclosure performs operations to generate a response to the rewritten query (for example, generated at block 610). In some aspects, after block 610, the process illustrated in FIG. 6 continues at block 614.

At block 614, a processing device implementing the present disclosure performs operations to provide the response (for example, generated at block 612) using a user interface. In some aspects, after block 614, the process illustrated in FIG. 6 terminates. In some aspects, not shown in FIG. 6, after block 614, the process illustrated in FIG. 6 continues at block 602, to create a new AI agent. In some aspects, not shown in FIG. 6, after block 614, the process illustrated in FIG. 6 continues at block 604 to receive, at the existing AI agent, a new query that references a set of user documents and a request for priority ingestion. In some aspects, not shown in FIG. 6, after block 614, the process illustrated in FIG. 6 continues at block 604 to receive, at the existing AI agent, a new query that references the previously ingested set of user documents.

Although not illustrated in FIG. 6, in some configurations, the operations of the process illustrated in FIG. 6 are performed in a different order than that described. In some configurations, where operations are performed in a different order, some of the operations are performed in parallel by a plurality of devices such as those described herein, using a plurality of threads. As may be contemplated, other orders in which to perform the operations illustrated in flow diagram 600 may be considered as being within the scope of the present disclosure.

### Other Data Flows

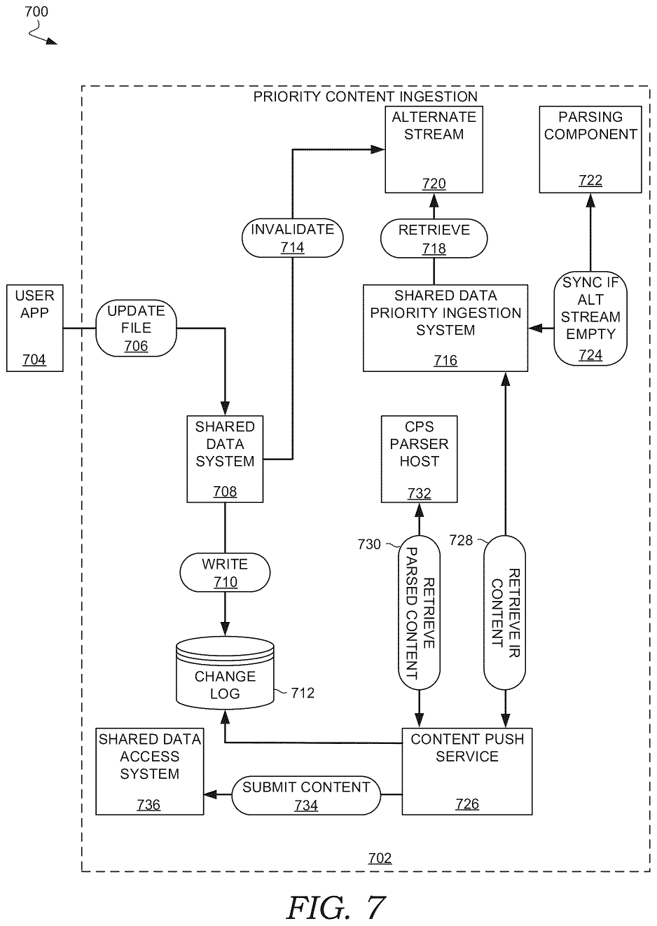

With reference to FIGS. 7, 8, 9, and 10, block diagrams are provided illustrating other data flows associated with systems and methods for performing priority content ingestion using a content ingestion system 104, described herein. The data flows depicted may be associated with priority content ingestion 302 described herein.

FIG. 7 is a block diagram 700 illustrating data flow of update operations for priority content ingestion in a content ingestion system, in accordance with aspects of the technology described herein. The data flow illustrated in block diagram 700 is similar to the data flow shown in block diagram 300 except that in block diagram 300, operations to ingest new content are illustrated while in block diagram 700, operations to update existing content are illustrated.

When a user application 704 (for example, user application 108) performs a request to update a previously ingested file using priority content ingestion 702, priority content ingestion 702 performs an operation to update a file 706 in a shared data system 708 (for example, a shared data system such as shared data system 310, described above). When the operation to update a file 706 in a shared data system 708 is performed, the shared data system 708 performs a write operation 710 to a change log 712, recording the operation to update the file. As described above, at least in connection with FIG. 3, whenever a file is added, modified, deleted, or moved to different location, events are written the change log 712 so that a content push service 726 can identify the changes and process them accordingly.

The shared data system 708 then invalidates 714 the previous data associated with the file to be updated (for example, the index) in an alternate stream 720 (for example, the alternate stream 326, described above). When the shared data priority ingestion system 716 subsequently tries to retrieve 718 the data from the alternate stream 720, the shared data priority ingestion system 716 can only do so if the alternate stream 720 exists (for example, if it was not previously invalidated). If the alternate stream 720 is empty (for example, was invalidated), the shared data priority ingestion system 716 uses a parsing component 722 to perform media transformation and analytics to parse the new version of the file (for example, the file to be updated) and synchronizes 724 the parsed data from the parsing component 722.

When the parsed data is either retrieved 718 from the alternate stream 720 or received from the parsing component 722, a content push service 726 can retrieve the IR content 728 from the shared data priority ingestion system 716 and retrieves the parsed content 730 from a content push service parser host 732, as described above.

Finally, the content push service 726 stores a backup event in the change log 712 (not shown in FIG. 7) and submits the content 734 to a shared data access system 736, which is a SDAS used by other computing systems (for example, AI systems and/or other systems) to access context derived from user content. In some embodiments, not shown in FIG. 7, a plurality of threads is used to implement aspects of priority content ingestion 702 so that, as each file is updated, various steps of priority content ingestion 702 are performed concurrently and/or in parallel.

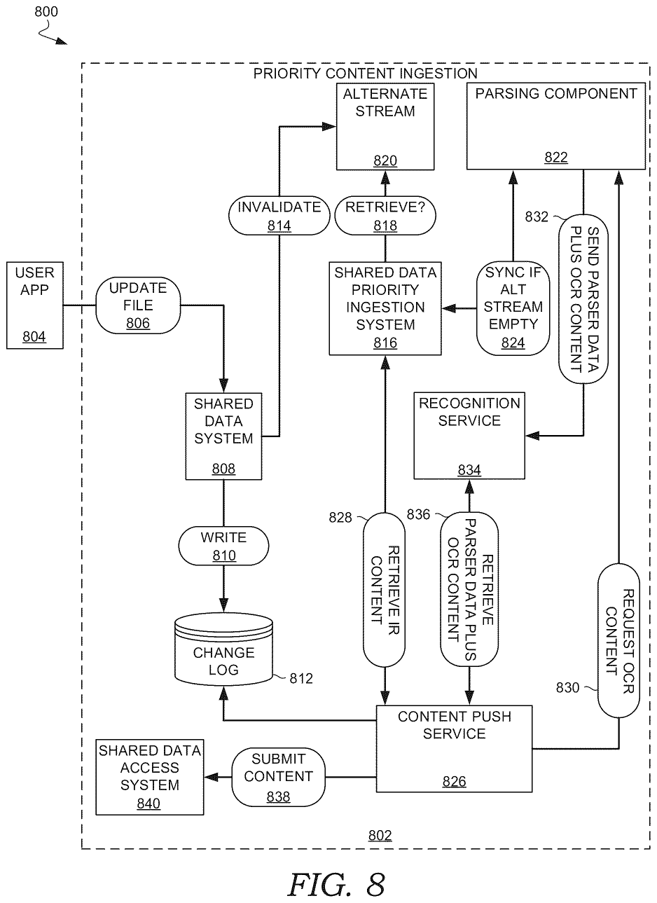

FIG. 8 is a block diagram 800 illustrating data flow of update operations with optical character recognition for priority content ingestion in a content ingestion system, in accordance with aspects of the technology described herein. The data flow illustrated in block diagram 800 is similar to the data flow shown in block diagram 700 except that in block diagram 800, the content ingestion includes OCR processing of the document.

When a user application 804 (for example, user application 108) performs a request to update a previously ingested file that includes OCR data using priority content ingestion 802, priority content ingestion 802 performs an operation to update a file 806 in a shared data system 808 (for example, a shared data system such as shared data system 310, described above). When the operation to update the file 806 in a shared data system 808 is performed, the shared data system 808 performs a write operation 810 to a change log 812, recording the operation to update the file, as described above.

The shared data system 808 then invalidates 814 the previous data associated with the file to be updated (for example, the index) in an alternate stream 820 (for example, the alternate stream 326, described above). When the shared data priority ingestion system 816 subsequently tries to retrieve 818 the data from the alternate stream 820, the shared data priority ingestion system 816 can only do so if the alternate stream 820 exists (for example, if was not previously invalidated). If the alternate stream 820 is empty (for example, it was invalidated), the shared data priority ingestion system 816 uses a parsing component 822 to perform media transformation and analytics to parse the new version of the file (for example, the file to be updated) and synchronizes 824 the parsed data from the parsing component 822.

When the parsed data is either retrieved 818 from the alternate stream 820 or received from the parsing component 822, a content push service 826 can retrieve the IR content 828 from the shared data priority ingestion system 816. Additionally, when the document includes optical character recognition (OCR) data, the content push service 826 can send a request for the OCR content 830 to the parsing component 822, which sends the parser data and the OCR content 832 to a recognition service 834 that performs operations associated with text extraction and semantic recognition of content. The recognition service 834 determines context and meaning of the text using natural language processing (NLP). The content push service 826 can then retrieve the parser data and the OCR content 836 from the recognition service 834.

Finally, the content push service 826 executes a query (for example, a backup event) to the change log 812 as described above and submits the content 838 to a shared data access system 840, as described above. In some embodiments, not shown in FIG. 8, a plurality of threads are used to implement aspects of priority content ingestion 802 so that, as each file is updated, various steps of priority content ingestion 802 are performed concurrently and/or in parallel.

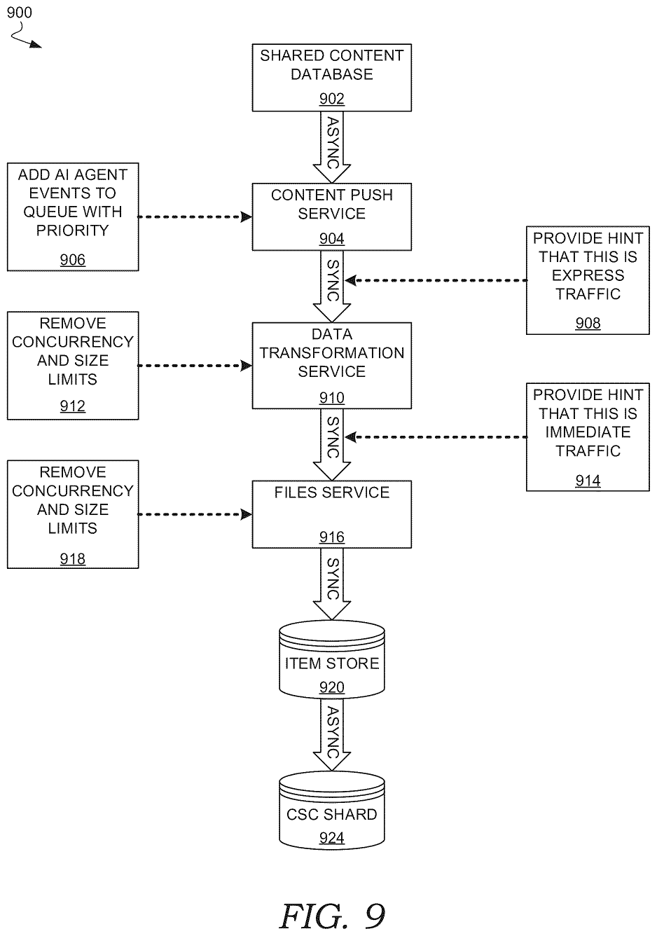

FIG. 9 is a block diagram 900 illustrating data flow for primary ingestion using priority content ingestion in a content ingestion system, in accordance with aspects of the technology described herein. When a shared content database 902 sends an asynchronous request to ingest files to a content push service 904, AI agent events are added to a processing queue with high priority 906. It should be noted that, while the request from the shared content database 902 to the content push service 904 is shown as asynchronous, under priority content ingestion, the request becomes nearly synchronous (for example, pseudosynchronous) in that it is performed in near real-time.

The content push service 904 then synchronously sends a request to parse the files to a data transformation service 910. As used herein, a data transformation service 910 is a service that embodies a transformation between data stored on a shared data system such as shared data system 310 and data stored on a shared data access system such as shared data access system 342. The synchronous request from the content push service 904 to the data transformation service 910 can include a hint that this is express traffic 908, enabling the data transformation service 910 to remove any concurrency and size limits 912 associated with processing the request. This hint that this is express traffic 908, enabling the data transformation service 910 to remove any concurrency and size limits 912 is an example of removing static limits on uploading and vectoring the index. The indication to remove any concurrency and size limits 912 associated with processing the request can also reduce the concurrency and size limits, as described above. This removal or reduction of concurrency and size limits causes a computing system implementing the data flow illustrated in FIG. 9 to reassign resources from lower priority ingestion (for example, standard ingestion) operations to the priority ingestion.

The data transformation service 910 then synchronously sends a request to store the data to a files service 916. As used herein, a files service 916 manages the storage of files and, in some embodiments, can provide information about the files to other systems such as those described herein. The synchronous request from the data transformation service 910 to the files service 916 can include a hint that this is immediate traffic 914, enabling the files service 916 to also remove any concurrency and size limits 918 associated with processing the request. This hint that this immediate traffic 914, allowing the files service 916 to remove concurrency and size limits 918 is an example of removing static limits on uploading and vectoring the index, as described above.

Finally, the files service 916 performs a synchronous request to store the ingested content to an item store 920. Once the ingested content is stored in the item store 920, the data can be asynchronously stored in a content shard collections shard (CSC shard 924), which corresponds to a distributed mailbox/shard system that stores the content indexes and metadata.

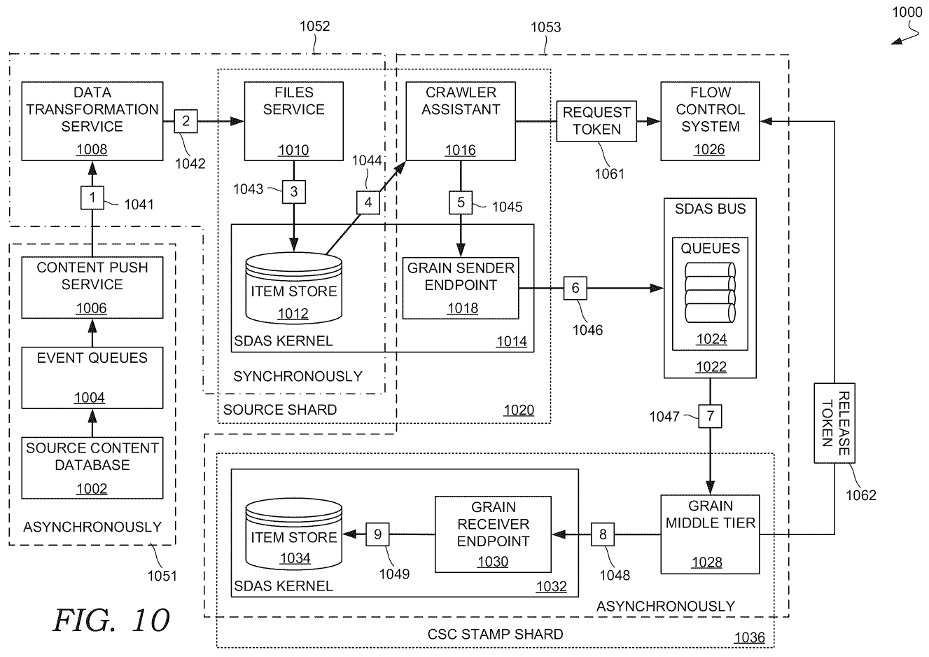

FIG. 10 is a block diagram 1000 illustrating asynchronous and synchronous data flow within priority content ingestion in a content ingestion system, in accordance with aspects of the technology described herein. First a source content database 1002 provides an indication that priority ingestion is to be performed to event queues 1004, and the event queues 1004 then provide instructions to a content push service 1006 to perform the priority ingestion. These three operations are performed asynchronously 1051.

The content push service 1006 then performs a first operation 1041 to provide a request priority ingestion to a data transformation service 1008, and the data transformation service 1008 performs a second operation 1042 to provide the ingested content to a files service 1010. The files service then performs a third operation 1043 to store the ingested content in an item store 1012 of a SDAS kernel 1014. The SDAS kernel 1014 is responsible for managing the underlying storage infrastructure, ensuring data integrity, and facilitating efficient retrieval of stored content through its integrated data management and indexing mechanisms.

The item store 1012 then performs a fourth operation 1044 to provide the ingested content to crawler assistant 1016, which is a component that assists in crawling and extracting data from the ingested content. The first operation 1041, the second operation 1042, the third operation 1043, and the fourth operation 1044 are performed synchronously 1052 (for example, in the order indicated). The crawler assistant 1016 then performs a fifth operation 1045 to provide the processed data to a grain sender endpoint 1018 of the SDAS kernel 1014, which is a component of the SDAS kernel 1014 that handles the distribution of processed data. As illustrated in FIG. 10, the files service 1010, the SDAS kernel 1014 (including the item store 1012 and the grain sender endpoint 1018), and the crawler assistant 1016 are elements of a source shard 1020, which is a partition of the data storage system that includes the files service, SDAS kernel 1014, and crawler assistant 1016. The crawler assistant 1016 then sends a request token 1061 to a flow control system 1026 that manages the flow of data during priority content ingestion.

Meanwhile, the grain sender endpoint 1018 performs a sixth operation 1046 to provide the processed data to a SDAS bus 1022 that comprises one or more queues 1024. The SDAS bus 1022 is responsible for managing data flow and communication between different components, and the queues 1024 are used to temporarily store data to manage and balance the load during data processing. The SDAS bus 1022 then performs a seventh operation 1047 to provide the queued data to a grain middle tier 1028, which is a component that processes and routes the data to its final destination.

The grain middle tier 1028 then sends a release token 1062 to the flow control system 1026, causing the processing to continue. The grain middle tier also performs an eighth operation to provide the processed data to a grain receiver endpoint 1030 of a SDAS kernel 1032. As used herein, a grain receiver endpoint 1030 is a component that receives and processes data within the SDAS kernel 1032, and a SDAS kernel 1032 is responsible for managing the underlying storage infrastructure and ensuring data integrity. Finally, the grain receiver endpoint 1030 performs a ninth operation 1049 to provide the processed data to an item store 1034 of the SDAS kernel 1032. As illustrated in FIG. 10, the grain middle tier 1028 and the SDAS kernel 1032 (including the grain receiver endpoint 1030 and the item store 1034) are elements of an CSC stamp shard 1036, which is a partition of the data storage system that includes the grain middle tier, SDAS kernel, grain receiver endpoint, and item store. The fifth operation 1045, the sixth operation 1046, the seventh operation 1047, the eighth operation 1048, and the ninth operation 1049 are performed asynchronously 1053 (for example, in any convenient order).

### Technical Improvement

Embodiments of the present techniques have been described with reference to several inventive features (for example, operations, systems, engines, and components) associated with an artificial intelligence system. Inventive features described include: operations, interfaces, data structures, and arrangements of computing resources associated with providing the functionality described herein relative to and with reference to a content ingestion system 104. Functionality of the embodiments of the present invention have further been described, by way of an implementation and examples, to demonstrate that the operations for providing the content ingestion system 104 as a solution to a specific problem in artificial systems technology to improve computing operations in artificial intelligence systems. By way of illustration, the content ingestion system 104 supports identifying, curating, and synthesizing context, and further supports generating a contextually accurate response to queries using the context via the contextual response generation. When using priority content ingestion, as described herein, contextual response generation can quickly integrate the context with user queries to quickly generate contextually accurate responses to user queries In particular, a contextual response generation engine may leverage AI in various ways to provide enhanced functionality and provide users with contextually accurate responses to queries. For example, a user can provide a query and context embodied in user documents and, using priority content ingestion, contextually accurate responses can be quickly provided. Hence, the response that is generated for the user query is much better (for example, more contextually accurate) and can be provided considerably faster than if the content was ingested using traditional methods (for example, asynchronously).

### Additional Support for Detailed Description

### Example Artificial Intelligence (AI) System in a Computing Environment

Referring now to FIG. 11, FIG. 11 illustrates a computing environment in which implementations of the present disclosure may be employed. In particular, FIG. 11 shows a high-level architecture of an example cloud computing platform 1100, artificial intelligence (AI) system 1100A, and computing system 1110 that can host a technical solution environment. It should be understood that this and other arrangements described herein are set forth only as examples. For example, as described above, many of the elements described herein may be implemented as discrete or distributed components or in conjunction with other components, and in any suitable combination and location. Other arrangements and elements (for example, machines, interfaces, functions, orders, and groupings of functions) can be used in addition to or instead of those shown.

The cloud computing platform 1100 provides computing system resources for different types of managed computing environments. For example, the cloud computing platform supports delivery of computing services-including compute, servers, storage, databases, networking, and intelligence. The components of cloud computing platform 1100 may communicate with each other over a network 1100B which may include, without limitation, one or more local area networks (LANs) and/or wide area networks (WANs).

The AI system 1100A provides a specialized infrastructure designed to support the computational demands of artificial intelligence (AI) workloads, including both training and inference tasks. The AI backend network system 1100A consists of interconnected components that facilitate the efficient processing, communication, and management of data within a distributed computing environment. Operations include data processing, handling input data, intermediate results, and output data, alongside complex computations for AI tasks, communication facilitating seamless interaction among components, and resource management overseeing optimal utilization of compute nodes, accelerators (for example, GPUs, PPUs, TPUs, etc.), memory, and storage. Interfaces encompass network interfaces enabling high-speed communication between nodes, APIs providing standardized interaction methods for developers, and management interfaces for system monitoring and administration. Data support functionalities include storage, data movement, transformation, and replication with backup mechanisms, ensuring data durability and reliability. In this way, the AI backend network system serves as the backbone infrastructure for AI workloads, facilitating efficient and scalable AI processing across distributed computing environments through its comprehensive operations, interfaces, and data management functionalities.

The cloud computing platform 1100 provides the foundational infrastructure and resources for deploying and managing computing workloads, including AI. AI system 1100A includes specialized infrastructures tailored for supporting the unique computational demands of AI workloads. The relationship between the two involves resource provisioning, integration, orchestration, and data processing, enabling organizations to leverage cloud-based resources effectively for AI development and deployment.

The computing system 1110 provides computing functionality for computing environments. For example, the computing system 1110 is a platform or framework that leverages advanced technologies such as artificial intelligence (AI), machine learning (ML), data mining, and big data analytics to extract actionable insights and knowledge from large and complex datasets. In this way, the computing system 1110 provides a computing environment that enables organizations to make informed decisions and optimize operations.

The computing system 1110 includes a computing engine 1120 that is a computing environment that supports executing computational tasks associated with the computing system 1110. The computing engine 1120 can be a hardware or software component that performs computational operations, such as mathematical calculations, data processing, and algorithm execution. The computing system 1110 integrates computing resources 1130 into computing system 1110 to effectively provide computing functionality in a computing environment.

The computing resources 1130 refer to computing elements (for example, components, capability, or entities) that collectively enable the operations of the computing engine 1120. The computing resources 1130 encompass a spectrum of computing elements, beginning with the diverse operations the computing resources 1130 can perform, ranging from complex computations to data manipulations. Interfaces, an integral part of the computing resources 1130, provide the means for both user interaction and seamless integration with external systems, ensuring a dynamic and interactive computing experience. The data facet of the data computing resources 1130 involves various types: input data, which is the information provided for processing; processing data, representing the data manipulated during computational tasks; and output data, the results generated by the computing engine 1120. In this way, the computing resources 1130 support the broader computing engine 1120 and computing system 1110.

Machine learning engine 1140 is a machine learning framework or library that operates as a tool for providing infrastructure, algorithms, and capabilities for designing, training, and deploying machine learning models. The machine learning engine 1140 can include pre-built functions and APIs that enable building and applying machine learning techniques. The machine learning engine 1140 can provide a machine learning workflow from data processing and feature extraction to model training, evaluation, and deployment.

Machine learning data 1142 refers to the structured or unstructured information used to train, validate, and test machine learning models. This machine learning data 1142 typically comprises input features (also known as independent variables or predictors) and their corresponding target values (also known as dependent variables or labels). Machine learning data 1142 can come from various sources, such as databases, sensor readings, text documents, images, audio recordings, or streaming data sources. Machine learning data 1142 may require preprocessing, cleaning, and transformation to ensure its suitability for training machine learning models. Additionally, machine learning data 1142 is often divided into training, validation, and testing sets to assess the performance and generalization ability of trained models accurately.

Machine learning models 1144 are algorithms or mathematical representations that learn patterns and relationships from the provided data to make predictions or decisions without being explicitly programmed. Machine learning models 1144 are trained using the machine learning data 1142, where they iteratively adjust their internal parameters or coefficients to minimize prediction errors or maximize performance metrics. Machine learning models 1144 can be classified into various types based on their learning algorithms and the nature of the problem they address, including supervised learning models (for example, regression, classification, etc.), unsupervised learning models (for example, clustering, dimensionality reduction, etc.), and reinforcement learning models. Once trained, machine learning models 1144 can be deployed in production environments to make predictions on new, unseen data instances. Regular evaluation and monitoring of model performance are essential to ensure their accuracy, reliability, and effectiveness in real-world applications.

The computing client 1150 supports access to computing system 1110. The computing client 1150 can be provided as a user client or an administrator client to support user and administrator functionality associated with the computing environment 1160, computing engine 1120, or computing system 1110. The computing client 1150 can also support accessing computing visualizations and causing display of the computing visualization. The computing client 1150 can include a computing engine client that supports receiving computing information associated with output of computing engine 1120 from computing system 1110 and causing presentation of the computing information. The computing information can specifically include computing visualizations associated with the output of the computing engine 1120.

Computing environment 1160 is a computing environment that is integrated into the computing system 1110. The computing environment 1160 is characterized by an infrastructure, where data from various sources within the ecosystem, including servers, networks, applications, sensors, and user interactions can be aggregated and processed by the computing system 1110 to perform computing tasks. The computing environment 1160 can be associated with middleware and integration layers that facilitate seamless data flow, while computing infrastructure, encompassing cloud-based resources, distributed computing frameworks, and optimized storage systems support functionality associated with the computing.

### Example Distributed Computing System Environment

Referring now to FIG. 12, FIG. 12 illustrates an example distributed computing environment 1200 in which implementations of the present disclosure may be employed. In particular, FIG. 12 shows a high-level architecture of an example cloud computing platform 1210 that can host a technical solution environment, or a portion thereof (for example, a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (for example, machines, interfaces, functions, orders, and groupings of functions) can be used in addition to or instead of those shown.

Data centers can support distributed computing environment 1200 that includes cloud computing platform 1210, rack 1220, and node 1230 (for example, computing devices, processing units, or blades) in rack 1220. The technical solution environment can be implemented with cloud computing platform 1210 that runs cloud services across different data centers and geographic regions. Cloud computing platform 1210 can implement a fabric controller 1240 component for provisioning and managing resource allocation, deployment, upgrade, and management of cloud services. Typically, cloud computing platform 1210 acts to store data or run service applications in a distributed manner. Cloud computing platform 1210 in a data center can be configured to host and support operation of endpoints of a particular service application. Cloud computing platform 1210 may be a public cloud, a private cloud, or a dedicated cloud.

Node 1230 can be provisioned with host 1250 (for example, operating system or runtime environment) running a defined software stack on node 1230. Node 1230 can also be configured to perform specialized functionality (for example, compute nodes or storage nodes) within cloud computing platform 1210. Node 1230 is allocated to run one or more portions of a service application of a tenant. A tenant can refer to a customer utilizing resources of cloud computing platform 1210. Service application components of cloud computing platform 1210 that support a particular tenant can be referred to as a multi-tenant infrastructure or tenancy. The terms “service application,” “application,” or “service” are used interchangeably herein and broadly refer to any software, or portions of software, that run on top of, or access storage and compute device locations within, a datacenter.

When more than one separate service application is being supported by nodes 1230, nodes 1230 may be partitioned into virtual machines (for example, virtual machine 1252 and virtual machine 1254). Physical machines can also concurrently run separate service applications. The virtual machines or physical machines can be configured as individualized computing environments that are supported by resources 1260 (for example, hardware resources and software resources) in cloud computing platform 1210. It is contemplated that resources can be configured for specific service applications. Further, each service application may be divided into functional portions such that each functional portion is able to run on a separate virtual machine. In cloud computing platform 1210, multiple servers may be used to run service applications and perform data storage operations in a cluster. In particular, the servers may perform data operations independently but exposed as a single device referred to as a cluster. Each server in the cluster can be implemented as a node.

Client device 1280 may be linked to a service application in cloud computing platform 1210. Client device 1280 may be any type of computing device, which may correspond to computing environment 1200 described with reference to FIG. 12. For example, client device 1280 can be configured to issue commands to cloud computing platform 1210. In embodiments, client device 1280 may communicate with service applications through a virtual Internet Protocol (IP) and load balancer or other means that direct communication requests to designated endpoints in cloud computing platform 1210. The components of cloud computing platform 1210 may communicate with each other over a network (not shown), which may include, without limitation, one or more local area networks (LANs) and/or wide area networks (WANs).

### Example Computing Environment

Having briefly described an overview of embodiments of the present technical solution, an example operating environment in which embodiments of the present technical solution may be implemented is described below in order to provide a general context for various aspects of the present technical solution. Referring initially to FIG. 13 in particular, an example operating environment for implementing embodiments of the present technical solution is shown and designated generally as computing device 1300. Computing device 1300 is but one example of a suitable computing environment and is not intended to suggest any limitation as to the scope of use or functionality of the technical solution. Nor should computing device 1300 be interpreted as having any dependency or requirement relating to any one or combination of components illustrated.

The technical solution may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The technical solution may be practiced in a variety of system configurations, including handheld devices, consumer electronics, general-purpose computers, more specialty computing devices, etc. The technical solution may also be practiced in distributed computing environments where tasks are performed by remote-processing devices that are linked through a communications network.

With reference to FIG. 13, computing device 1300 includes bus 1310 that directly or indirectly couples the following devices: memory 1312, one or more processors 1314, one or more presentation components 1316, input/output ports 1318, input/output components 1320, and illustrative power supply 1322. Bus 1310 represents what may be one or more buses (such as an address bus, data bus, or combination thereof). The various blocks of FIG. 13 are shown with lines for the sake of conceptual clarity, and other arrangements of the described components and/or component functionality are also contemplated. For example, one may consider a presentation component such as a display device to be an input/output (I/O) component. Also, processors have memory. We recognize that such is the nature of the art, and reiterate that the diagram of FIG. 13 is merely illustrative of an example computing device that can be used in connection with one or more embodiments of the present technical solution. Distinction is not made between such categories as “workstation,” “server,” “laptop,” “handheld device,” etc., as all are contemplated within the scope of FIG. 13 and make reference to “computing device.”

Computing device 1300 typically includes a variety of computer-readable media. Computer-readable media can be any available media that can be accessed by computing device 1300 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium that can be used to store the desired information and which can be accessed by computing device 1300. Computer storage media excludes signals per se.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 1312 includes computer storage media in the form of volatile and/or nonvolatile memory. The memory may be removable, non-removable, or a combination thereof. Exemplary hardware devices include solid-state memory, hard drives, optical-disc drives, etc. Computing device 1300 includes one or more processors that read data from various entities such as memory 1312 or I/O components 1320. Presentation component(s) 1316 present data indications to a user or other device. Exemplary presentation components include a display device, speaker, printing component, vibrating component, etc.

I/O ports 1318 allow computing device 1300 to be logically coupled to other devices including I/O components 1320, some of which may be built-in. Illustrative components include a microphone, joystick, game pad, satellite dish, scanner, printer, wireless device, etc.

### Other Embodiments

In some embodiments, a computerized system ingests contextual data to generate responses in an artificial intelligence (AI) system with priority, such as the computerized system described in any of the embodiments above. The computerized system comprises at least one processor, and computer memory storing computer-readable instructions, that, when executed by the at least one processor, cause the at least one processor to perform operations. The operations comprise receiving a request for priority ingestion of content. The content comprises a set of one or more documents. The operations may further comprise indicating to prioritize the parsing of the set of documents. The indicating is to a document upload queue. The operations may further comprise receiving a document of the set of documents. The document is received at the document upload queue. The operations may further comprise parsing the document. The document is concurrently parsed, as it is received. The document is parsed to identify semantic content within the document. The semantic content is identified based on the request. The operations may further comprise processing the identified semantic content. The identified semantic content is processed to generate an index of the document. The index indicates locations within the document of the identified semantic content. The operations may further comprise providing the document and the index of the document to a shared data access system.

Advantageously, these and other embodiments, as described herein, improve existing computing technologies by providing new or improved functionality in computing applications including automated computing technology for programmatically performing prioritized ingestion of contextual data to generate responses in an artificial intelligence (AI) system. These improvements are provided through various applications or platforms, as described herein, and can be beneficial for enabling improved computing applications and an improved user computing experience. The embodiments described herein include several inventive features (for example, methods, operations, systems, engines, and components) associated with an artificial intelligence system having a priority content ingestion system. As described above, the priority content ingestion system supports identifying, curating, and synthesizing context from input content, and further supports generating a contextually accurate response to queries using a contextual response generation engine, allowing a user to quickly build up a context-aware AI agent to generate hypotheses and fine-tune responses that are contextually relevant. The responses that are generated by a language model are much better (for example, more contextually accurate) and can be more quickly obtained. Accordingly, applications or platforms, as provided herein, can be beneficial for enabling improved computing applications and an improved user computing experience. For example, automated computing technology for programmatically performing prioritized ingestion of contextual data to generate responses in an artificial intelligence (AI) system reduces the computing and networking resources utilized during communication between the user and an AI system by facilitating better and more accurate queries so that the user is not required to manually identify, access, process, and review contextual data for queries. In this regard, the computing and network resources are conserved. Further, embodiments of this disclosure address a need that arises from effectively using contextual data to inform AI-based queries. The actions/operations described herein are not a mere use of a computer, but address results of a system that is a direct consequence of software used as a service offered in conjunction with user communication through services hosted across a variety of platforms and devices. Further still, embodiments of this disclosure enable an improved user experience across a number of computer devices, applications, and platforms. Additionally, embodiments described herein enable context be programmatically determined and used without requiring computer tools and resources for a user to manually perform operations to produce this outcome. In this way, some embodiments, as described herein, reduce or eliminate a need for certain databases, data storage, computer resources, networking resources, and computer controls for enabling manually performed steps by an administrator, or the user themselves, to search, identify, assess, and configure (e.g., by hard-coding) specific, static data, thereby reducing the consumption of computing resources.

In any combination of the above embodiments of the computerized system, the request to ingest the content is received in conjunction with a query to a large language model.

In any combination of the above embodiments of the computerized system, the operations further comprise generating context information associated with the query based. The context information is based, at least in part, on obtaining the document and the index of the document from the shared data access system. The operations may further comprise rewriting the query. The query is rewritten using the context information. The query is rewritten to generate a context-aware query. The operations may further comprise submitting the context-aware query to the language model. The operations may further comprise causing a response to the context-aware query to be provided. The response is provided via a user interface.

In any combination of the above embodiments of the computerized system, the operations further comprise receiving a request to update a document previously stored in the shared data access system using an updated document. The operations may further comprise invalidating the index of the document previously stored in the shared data access system. The operations may further comprise receiving the updated document. The operations may further comprise concurrently parsing the updated document, as it is received, to identify updated semantic content within the updated document. The operations may further comprise processing the identified updated semantic content to generate an updated index of the updated document that indicates locations within the updated document of the identified updated semantic content. The operations may further comprise providing the updated document and the updated index of the updated document to the shared data access system.

In any combination of the above embodiments of the computerized system, indicating, to the document upload queue, to prioritize the parsing of the set of documents comprises inserting the one or more documents of the set of documents at the front of the document upload queue.

In any combination of the above embodiments of the computerized system, the operations further comprise allocating additional computing resources of the system for concurrently parsing the document and processing the identified semantic content, in response to indicating to prioritize the parsing of the set of documents.

In any combination of the above embodiments of the computerized system, processing the identified semantic content to generate the index of the document that indicates locations within the document of the identified semantic content is performed using a content push service that obtains the identified semantic content from a shared data priority ingestion system.

In any combination of the above embodiments of the computerized system, parsing the document to identify the semantic content within the document is performed by a parsing component that provides a transformation between data stored in a shared data system and data stored in the shared data access system.

In some embodiments, a computer-implemented method to ingest contextual data to generate responses in an artificial intelligence (AI) system with priority, using any of the embodiments described above. The method comprises receiving a request to ingest content. The content comprises a set of one or more documents. The request comprises an indication to ingest the content with high priority. The method may further comprise indicating to prioritize the content ingestion of the set of documents. The indicating is to a document upload queue. The method may further comprise receiving a first document of the set of documents. The first document of the set of documents is received at the document upload queue. The method may further comprise using a parallel semantic indexing pipeline to concurrently parse the first document. The first document is parsed as it is received. The first document is parsed to identify semantic content within the first document. The semantic content is identified based on the request. The method may further comprise providing the first document and the index of the first document to a shared data access system.

Advantageously, these and other embodiments, as described herein, improve existing computing technologies by providing new or improved functionality in computing applications including automated computing technology for programmatically performing prioritized ingestion of contextual data to generate responses in an artificial intelligence (AI) system. These improvements are provided through various applications or platforms, as described herein, and can be beneficial for enabling improved computing applications and an improved user computing experience. The embodiments described herein include several inventive features (for example, methods, operations, systems, engines, and components) associated with an artificial intelligence system having a priority content ingestion system. As described above, the priority content ingestion system supports identifying, curating, and synthesizing context from input content, and further supports generating a contextually accurate response to queries using a contextual response generation engine, allowing a user to quickly build up a context-aware AI agent to generate hypotheses and fine-tune responses that are contextually relevant. The responses that are generated by a language model are much better (for example, more contextually accurate) and can be more quickly obtained. Accordingly, applications or platforms, as provided herein, can be beneficial for enabling improved computing applications and an improved user computing experience. For example, automated computing technology for programmatically performing prioritized ingestion of contextual data to generate responses in an artificial intelligence (AI) system reduces the computing and networking resources utilized during communication between the user and an AI system by facilitating better and more accurate queries so that the user is not required to manually identify, access, process, and review contextual data for queries. In this regard, the computing and network resources are conserved. Further, embodiments of this disclosure address a need that arises from effectively using contextual data to inform AI-based queries. The actions/operations described herein are not a mere use of a computer, but address results of a system that is a direct consequence of software used as a service offered in conjunction with user communication through services hosted across a variety of platforms and devices. Further still, embodiments of this disclosure enable an improved user experience across a number of computer devices, applications, and platforms. Additionally, embodiments described herein enable context be programmatically determined and used without requiring computer tools and resources for a user to manually perform operations to produce this outcome. In this way, some embodiments, as described herein, reduce or eliminate a need for certain databases, data storage, computer resources, networking resources, and computer controls for enabling manually performed steps by an administrator, or the user themselves, to search, identify, assess, and configure (e.g., by hard-coding) specific, static data, thereby reducing the consumption of computing resources.

In any combination of the above embodiments, the method further comprises receiving a query to an artificial intelligence system. The query includes the request to ingest content. The method may further comprise generating context information associated with the query. The context information is based, at least in part, on obtaining the first document and the index of the first document from the shared data access system. The method may further comprise rewriting the query using the context information to generate a context-aware query. The method may further comprise submitting the context-aware query to the artificial intelligence system. The method may further comprise causing a response to the context-aware query to be provided. The response to the context-aware query is provided via a user interface.

In any combination of the above embodiments, the method further comprises receiving a request to update a second document stored in the shared data access system using an updated document. The method may further comprise invalidating the index of the second document. The method may further comprise receiving the updated document to replace the contents of the second document. The method may further comprise concurrently parsing the updated document, as it is received, to identify updated semantic content within the updated document. The method may further comprise processing the identified updated semantic content to generate an updated index of the second document that indicates locations within the second document of the identified updated semantic content. The method may further comprise associating the updated index with the second document in the shared data access system.

In any combination of the above embodiments, the method further comprises receiving a query to an artificial intelligence system, the query including the request to ingest content. The method may further comprise generating context information associated with the query based, at least in part, on the set of documents. The method may further comprise updating the context information based, at least in part, on a set of previously uploaded documents and associated indices stored in the shared data access system. The method may further comprise rewriting the query using the context information to generate a context-aware query. The method may further comprise submitting the context-aware query to the artificial intelligence system. The method may further comprise causing a response to the context-aware query to be provided via a user interface.

In any combination of the above embodiments, the method further comprises receiving, from a computing system, a request for the first document and the index of the first document. The method may further comprise obtaining the first document and the index of the first document from the shared data access system. The method may further comprise providing the obtained first document and index of the first document via a user interface.

In any combination of the above embodiments, prioritizing the content ingestion of the set of documents comprises removing a static limit in the document upload queue on uploading the documents of the set of documents.

In some embodiments, one or more computer storage media having computer-executable instructions embodied thereon that, when executed by a computing system having at least one processor and at least one memory, cause the at least one processor to perform operations. The operations comprise creating an artificial intelligence (AI) agent. The operations may further comprise receiving, at the AI agent, a first query that references a set of documents and a request for priority ingestion of the set of documents. The operations may further comprise generating, by the AI agent, a request to ingest the set of user documents with priority. The operations may further comprise removing one or more static limits on uploading and indexing the set of user documents. The operations may further comprise storing the set of user documents and a set of indices of the set of user documents in a shared data access system. The operations may further comprise obtaining context of the first query based, at least in part, on the set of indices of the set of user documents obtained from the shared data access system. The operations may further comprise rewriting the first query using the context of the first query to generate a first rewritten query. The operations may further comprise generating, using an AI system, a response to the first rewritten query. The operations may further comprise providing the response to the first rewritten query using a user interface.

Advantageously, these and other embodiments, as described herein, improve existing computing technologies by providing new or improved functionality in computing applications including automated computing technology for programmatically performing prioritized ingestion of contextual data to generate responses in an artificial intelligence (AI) system. These improvements are provided through various applications or platforms, as described herein, and can be beneficial for enabling improved computing applications and an improved user computing experience. The embodiments described herein include several inventive features (for example, methods, operations, systems, engines, and components) associated with an artificial intelligence system having a priority content ingestion system. As described above, the priority content ingestion system supports identifying, curating, and synthesizing context from input content, and further supports generating a contextually accurate response to queries using a contextual response generation engine, allowing a user to quickly build up a context-aware AI agent to generate hypotheses and fine-tune responses that are contextually relevant. The responses that are generated by a language model are much better (for example, more contextually accurate) and can be more quickly obtained. Accordingly, applications or platforms, as provided herein, can be beneficial for enabling improved computing applications and an improved user computing experience. For example, automated computing technology for programmatically performing prioritized ingestion of contextual data to generate responses in an artificial intelligence (AI) system reduces the computing and networking resources utilized during communication between the user and an AI system by facilitating better and more accurate queries so that the user is not required to manually identify, access, process, and review contextual data for queries. In this regard, the computing and network resources are conserved. Further, embodiments of this disclosure address a need that arises from effectively using contextual data to inform AI-based queries. The actions/operations described herein are not a mere use of a computer, but address results of a system that is a direct consequence of software used as a service offered in conjunction with user communication through services hosted across a variety of platforms and devices. Further still, embodiments of this disclosure enable an improved user experience across a number of computer devices, applications, and platforms. Additionally, embodiments described herein enable context be programmatically determined and used without requiring computer tools and resources for a user to manually perform operations to produce this outcome. In this way, some embodiments, as described herein, reduce or eliminate a need for certain databases, data storage, computer resources, networking resources, and computer controls for enabling manually performed steps by an administrator, or the user themselves, to search, identify, assess, and configure (e.g., by hard-coding) specific, static data, thereby reducing the consumption of computing resources.

In any combination of the above embodiments, the operations further comprise generating the set of indices of the set of user documents by parsing the set of documents to identify semantic and lexical content within the set of documents and processing the identified semantic and lexical content.

In any combination of the above embodiments, the context of the first query is based, at least in part, on a set of indices of other documents obtained from the shared data access system.

In any combination of the above embodiments, the operations further comprise receiving, at the AI agent, a second query that references the set of user documents. The operations may further comprise rewriting the second query using the context of the first query to generate a second rewritten query. The operations may further comprise generating, using an AI system, a response to the second rewritten query. The operations may further comprise providing the response to the second rewritten query using the user interface.

In any combination of the above embodiments, the operations further comprise receiving, at the AI agent, a second query that references the response to the first rewritten query. The operations may further comprise rewriting the second query using the response to the first rewritten query to generate a second rewritten query. The operations may further comprise generating, using an AI system, a response to the second rewritten query. The operations may further comprise providing the response to the second rewritten query using the user interface.

In any combination of the above embodiments, the operations further comprise receiving, at the AI agent, a request to update a document previously stored in the shared data access system using an updated document. The operations may further comprise invalidating an index of the document previously stored in the shared data access system. The operations may further comprise receiving the updated document. The operations may further comprise concurrently parsing the updated document, as it is received, to identify updated semantic content within the updated document. The operations may further comprise processing the identified updated semantic content to generate an updated index of the updated document that indicates locations within the updated document of the identified updated semantic content. The operations may further comprise providing the updated document and the updated index of the updated document to the shared data access system.

### Additional Structural and Functional Features

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (for example, machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the technical solution is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technical solution are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present technical solution may generally refer to the technical solution environment and the schematics described herein, it is understood that the techniques described may be extended to other implementation contexts.

For purposes of this disclosure the word “support” refers to the provisioning of functionality, services, or assistance by a computing component or through computing operations within a broader computing system. When a computing component or set of operations supports a specific functionality, it means that it plays a role in enabling or executing that particular aspect of the computing system. This support can manifest in various ways, including the processing of data, execution of operations, management of resources, and ensuring compatibility or interoperability with other components. Additionally, support may involve providing interfaces, APIs (Application Programming Interfaces), or protocols that allow seamless interaction and integration with other elements of the computing system. The concept of support extends beyond mere functionality provision to encompass maintenance, troubleshooting, and the overall optimization of computing resources to ensure the robust and efficient operation of the computing system.

Embodiments of the present technical solution have been described in relation to particular embodiments which are intended in all respects to be illustrative rather than restrictive. Alternative embodiments will become apparent to those of ordinary skill in the art to which the present technical solution pertains without departing from its scope.

From the foregoing, it will be seen that this technical solution is one well-adapted to attain all the ends and objects hereinabove set forth together with other advantages which are obvious and which are inherent to the structure.

It will be understood that certain features and subcombinations are of utility and may be employed without reference to other features or subcombinations. This is contemplated by and is within the scope of the claims.

What is claimed is:

1. A computerized system comprising:
at least one computer processor; and
computer memory storing computer-useable instructions that, when used by the at least one computer processor, cause the at least one computer processor to perform operations, the operations comprising:
receiving a request for priority ingestion of content comprising a set of one or more documents;
indicating, to a document upload queue, to prioritize the parsing of the set of documents;
receiving, at the document upload queue, a document of the set of documents;
concurrently parsing the document, as it is received, to identify semantic content within the document, based on the request;
processing the identified semantic content to generate an index of the document that indicates locations within the document of the identified semantic content; and
providing the document and the index of the document to a shared data access system.

2. The system of claim 1, wherein the request to ingest the content is received in conjunction with a query to a language model.

3. The system of claim 2, wherein the operations further comprise:
generating context information associated with the query based, at least in part, on obtaining the document and the index of the document from the shared data access system;
rewriting the query using the context information to generate a context-aware query;
submitting the context-aware query to the language model; and
causing a response to the context-aware query to be provided via a user interface.

4. The system of claim 1, wherein the operations further comprise:
receiving a request to update a document previously stored in the shared data access system using an updated document;
invalidating the index of the document previously stored in the shared data access system;
receiving the updated document;
concurrently parsing the updated document, as it is received, to identify updated semantic content within the updated document;
processing the identified updated semantic content to generate an updated index of the updated document that indicates locations within the updated document of the identified updated semantic content; and
providing the updated document and the updated index of the updated document to the shared data access system.

5. The system of claim 1, wherein indicating, to the document upload queue, to prioritize the parsing of the set of documents comprises inserting the one or more documents of the set of documents at the front of the document upload queue.

6. The system of claim 1, further comprising:
allocating additional computing resources of the system for concurrently parsing the document and processing the identified semantic content, in response to indicating to prioritize the parsing of the set of documents.

7. The system of claim 1, wherein processing the identified semantic content to generate the index of the document that indicates locations within the document of the identified semantic content is performed using a content push service that obtains the identified semantic content from a shared data priority ingestion system.

8. The system of claim 1, wherein parsing the document to identify the semantic content within the document is performed by a parsing component that provides a transformation between data stored in a shared data system and data stored in the shared data access system.

9. A computer-implemented method, the method comprising:
receiving a request to ingest content comprising a set of one or more documents, the request comprising an indication to ingest the content with high priority;
indicating, to a document upload queue, to prioritize the content ingestion of the set of documents;
receiving, at the document upload queue, a first document of the set of documents;
using a parallel semantic indexing pipeline to concurrently parse the first document, as it is received, to identify semantic content within the first document, based on the request;
processing the identified semantic content to generate an index of the first document that indicates locations within the first document of the identified semantic content; and
providing the first document and the index of the first document to a shared data access system.

10. The method of claim 9, the method further comprising:
receiving a query to an artificial intelligence system, the query including the request to ingest content;
generating context information associated with the query based, at least in part, on obtaining the first document and the index of the first document from the shared data access system;
rewriting the query using the context information to generate a context-aware query;
submitting the context-aware query to the artificial intelligence system; and
causing a response to the context-aware query to be provided via a user interface.

11. The method of claim 9, the method further comprising:
receiving a request to update a second document stored in the shared data access system using an updated document;
invalidating the index of the second document;
receiving the updated document to replace the contents of the second document;
concurrently parsing the updated document, as it is received, to identify updated semantic content within the updated document;
processing the identified updated semantic content to generate an updated index of the second document that indicates locations within the second document of the identified updated semantic content; and
associating the updated index with the second document in the shared data access system.

12. The method of claim 9, the method further comprising:
receiving a query to an artificial intelligence system, the query including the request to ingest content;
generating context information associated with the query based, at least in part, on the set of documents;
updating the context information based, at least in part, on a set of previously uploaded documents and associated indices stored in the shared data access system;
rewriting the query using the context information to generate a context-aware query;
submitting the context-aware query to the artificial intelligence system; and
causing a response to the context-aware query to be provided via a user interface.

13. The method of claim 9, the method further comprising:
receiving, from a computing system, a request for the first document and the index of the first document;
obtaining the first document and the index of the first document from the shared data access system; and
providing the obtained first document and index of the first document via a user interface.

14. The method of claim 8, wherein prioritizing the content ingestion of the set of documents comprises removing a static limit in the document upload queue on uploading the documents of the set of documents.

15. One or more computer-storage media having computer-executable instructions embodied thereon that, when executed by a computing system having a processor and memory, cause the processor to perform operations, the operations comprising:
creating an artificial intelligence (AI) agent;
receiving, at the AI agent, a first query that references a set of documents and a request for priority ingestion of the set of documents;
generating, by the AI agent, a request to ingest the set of user documents with priority;
removing one or more static limits on uploading and indexing the set of user documents;
storing the set of user documents and a set of indices of the set of user documents in a shared data access system;
obtaining context of the first query based, at least in part, on the set of indices of the set of user documents obtained from the shared data access system;
rewriting the first query using the context of the first query to generate a first rewritten query;
generating, using an AI system, a response to the first rewritten query; and
providing the response to the first rewritten query using a user interface.

16. The media of claim 15, the operations further comprising:
generating the set of indices of the set of user documents by parsing the set of documents to identify semantic and lexical content within the set of documents and processing the identified semantic and lexical content.

17. The media of claim 15, wherein the context of the first query is based, at least in part, on a set of indices of other documents obtained from the shared data access system.

18. The media of claim 15, the operations further comprising:
receiving, at the AI agent, a second query that references the set of user documents;
rewriting the second query using the context of the first query to generate a second rewritten query;
generating, using an AI system, a response to the second rewritten query; and
providing the response to the second rewritten query using the user interface.

19. The media of claim 16, the operations further comprising:
receiving, at the AI agent, a second query that references the response to the first rewritten query;
rewriting the second query using the response to the first rewritten query to generate a second rewritten query;
generating, using an AI system, a response to the second rewritten query; and
providing the response to the second rewritten query using the user interface.

20. The media of claim 16, the operations further comprising:
receiving, at the AI agent, a request to update a document previously stored in the shared data access system using an updated document;
invalidating an index of the document previously stored in the shared data access system;
receiving the updated document;
concurrently parsing the updated document, as it is received, to identify updated semantic content within the updated document;
processing the identified updated semantic content to generate an updated index of the updated document that indicates locations within the updated document of the identified updated semantic content; and
providing the updated document and the updated index of the updated document to the shared data access system.
